(19) United States
(12) Patent Application Publication
(10) Pub. No.: US 2007/0091331 A1
(43) Pub. Date: Apr. 26, 2007

(54) PRINTING SUPPORT SYSTEM, PRINTING SUPPORT PROGRAM, STORAGE MEDIUM, AND PRINTING SUPPORT METHOD

(75) Inventor: Hirotaka OHASHI, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/552,689

(22) Filed: Oct. 25, 2006

(30) Foreign Application Priority Data
Oct. 26, 2005 (JP) 2005-311456
Aug. 7, 2006 (JP) 2006-214069

(51) Int. Cl. G06K 15/02

(52) U.S. Cl. 358/1.2; 358/528

(57) ABSTRACT

A printing support system that supports performing a printing process on the basis of document data allowing paper width and paper height to be set for each of a plurality of pages includes: a document data acquisition unit that acquires the document data; a finish paper size information acquisition unit that acquires finish paper size information indicating finish paper width and finish paper height of a printed material; a normalization rule storage unit that stores a plurality of normalization rules used to process the document data such that paper widths and paper heights of entire pages of the document data are adapted to the finish paper width and finish paper height of the finish paper size information; a normalization rule selection unit that selects the normalization rules in the normalization rule storage unit on the basis of the paper width and paper height of the document data acquired by the document data acquisition unit and the finish paper width and finish paper height of the finish paper size information acquired by the finish paper size information acquisition unit; and a document data processing unit that processes the document data acquired by the document data acquisition unit on the basis of the normalization rule selected by the normalization rule selection unit.

### BACKGROUND

1. Technical Field

The present invention relates to a system, a program, and a method that support performing a printing process on the basis of document data in which paper sizes are differently set, and in particular, to a printing support system, a printing support program, a storage medium, and a printing support method capable of obtaining a print result suitable for being cut for bookbinding and being page-folded.

2. Related Art

As a technique of obtaining a printed material corresponding to specifications that a document creator intends, there has been known a technique in which an electronic job ticket is created separately from document data to be printed and then a printing process is performed on the basis of the electronic job ticket and the document data. The electronic job ticket specifies specifications of a printed material including format information, such as a finish paper size, a print direction, allocation setting, or double-sided print setting, and finishing information such as a filing position.

Thus, since the specifications of the printed material can be separately set in the electronic job ticket, a paper size set in the document data (hereinafter, referred to as a ‘document set paper size’) and a finish paper size set in the electronic job ticket do not necessarily match each other. If the paper sizes are different from each other, it is not possible to properly perform an imposition process for bookbinding, which is performed on the assumption that the paper sizes match each other. Therefore, in the case when the paper sizes are different from each other, it is necessary to perform a process, such as rotation or enlargement/reduction, on document data such that the document data can properly correspond to the finish paper size.

As known techniques of processing document data when the paper sizes are different, there are techniques disclosed in JP-A-3-216370, JP-A-2004-199464, JP-A-11-48573, and JP-A-2005-56285, for example.

In the technique disclosed in JP-A-3-216370, when a set paper size is different from a print paper size, characters and figures included in a document are proportionally enlarged or reduced corresponding to the print paper size.

In the technique disclosed in JP-A-2004-199464, when performing a printing process on a job where A3-sized page data and A4-size page data are mixed, if division of the job is instructed, the page data corresponding to the A3 size larger than the A4 size as a standard size is sorted. Then, for the page data corresponding to the A3 size, a rasterized result thereof is divided into two parts on A4-sized paper and is then printed in a double-sided printing format or a single-sided printing format

In the technique disclosed in JP-A-11-48573, the data size of print data is detected and then the print paper size is determined by using a paper conversion map in which the detected data size corresponds to print paper. The paper conversion map has a data configuration in which one print paper corresponding to the data size is set and may set paper corresponding to a predetermined size as output paper. In addition, data output onto paper, which is determined by data conversion due to automatic enlargement/reduction and rotation functions, is guaranteed.

In the technique disclosed in JP-A-2005-56285, in the case when it is determined to be oversized, a plurality of conditions with respect to characteristics of a stored image and an output type with respect to each of the plurality of conditions are referred, the output type is determined on the basis of the characteristics of the image formed by image data, and an image output device is controlled such that the image is output in the determined output type on the basis of the image data.

However, in the technique disclosed in JP-A-3-216370, there is no choice but to perform the processing by using only a uniform processing method of enlargement/reduction. As a result, a problem has occurred where a proper print result may not be necessarily obtained according to the relation between a document set paper size and a finish paper size. For example, in the case when, as the document set paper size, two A4-vertical pages are disposed in A3-horizontal document data and the finish paper size is A4 in the vertical direction, it is proper to divide one A3-horizontal page into two A4-vertical pages rather than performing enlargement/reduction.

In addition, in the case of processing document data in which a paper size with respect to each of a plurality of pages can be set, for example, in the case of PDF (portable document format) file, it is not proper to perform only the uniform processing method. For example, in the case when a document paper size of a predetermined page of document data is set as an A3-horizontal arrangement and a document paper size of another page of the document data is set as a B4-vertical arrangement under the condition in which a finish paper size is set as an A4-vertical arrangement, that is, in the case when the relations between document paper sizes and finish paper sizes in a plurality of pages are different, it is preferable to select a proper processing method in consideration of the relation in the respective pages. It is desirable to perform a page division process on the former page and to perform a reduction process on the latter page.

Even in the techniques disclosed in JP-A-2004-199464, JP-A-11-48573, and JP-A-2005-56285, since a uniform processing method is used regardless of the document set paper size and the finish paper size, the same problem as in the technique disclosed in JP-A-3-216370 occurs.

Furthermore, even if document paper sizes are equal to one another, values of paper width and paper height of document data may be different according to applications. For example, in an application where A4-vertical arrangement is specified, a proper value of (297, 210) is specified, but in another application, a different value of (274.5, 190.1) may be specified. In the related art, there has been a problem in that proper processing cannot be performed in the case when respective applications are differently set to indicate the same paper sizes.

### SUMMARY

An advantage of some aspects of the invention is that it provides a printing support system, a printing support program, a storage medium, and a printing support method capable of obtaining a print result suitable for being cut for bookbinding and being page-folded.

According to a first apect of the invention, a printing support system that supports performing a printing process on the basis of document data allowing paper width and paper height to be set for each of a plurality of pages includes: a document data acquisition unit that acquires the document data; a finish paper size information acquisition unit that acquires finish paper size information indicating finish paper width and finish paper height of a printed material; a normalization rule storage unit that stores a plurality of normalization rules used to process the document data such that paper widths and paper heights of entire pages of the document data are adapted to the finish paper width and finish paper height of the finish paper size information; a normalization rule selection unit that selects the normalization rules in the normalization rule storage unit on the basis of the paper width and paper height of the document data acquired by the document data acquisition unit and the finish paper width and finish paper height of the finish paper size information acquired by the finish paper size information acquisition unit; and a document data processing unit that processes the document data acquired by the document data acquisition unit on the basis of the normalization rule selected by the normalization rule selection unit.

In the configuration described above, the document data and the finish paper size information are acquired by the document data acquisition unit and the finish paper size information acquisition unit. Then, by the normalization rule selection unit, the normalization rule is selected in the normalization rule storage unit on the basis of the paper width and paper height of the document data and the finish paper width and finish paper height of the finish paper size information that have been acquired. Then, the acquired document data is processed by the document data processing unit on the basis of the selected normalization rule. The document data is processed such that the paper widths and paper heights of the entire pages of the document data are adapted to the finish paper width and finish paper height of the finish paper size information.

Thus, the document data is processed in consideration of the relation between the paper width and paper height of the document data and the finish paper width and finish paper height of the finish paper size information. As a result, as compared with the related art, it is possible to obtain a print result suitable for being cut for bookbinding and being page-folded.

Here, the document data acquisition unit may have any kind of configuration as long as it can acquire the document data. For example, the document data may be input through an input device, or the document data may be acquired or received from an external device, or the document data may be read out from a storage unit or a storage medium. Accordingly, in order to acquire the document data, at least input, acquisition, reception, and reading is included. This is applied to the finish paper size information acquisition unit and other concepts of acquisition in the same manner.

In addition, the paper size information on setting of the paper width and the paper height may be configured to be included in the document data or to be separated from the document data. In the latter case, it is preferable that the document data and the paper size information be associated with each other. For example, information indicating the location of the paper size information, such as URL (uniform resource locator) or file path, may be basically set in the document data, information indicating the location of the document data may be basically set in the paper size information, or information indicating the locations of the document data and the paper size information may be basically set in the paper size information. Hereinafter, these are applied to a printing support program according to a twelfth aspect of the invention, a storage medium according to a twenty-third aspect of the invention, and a printing support method according to a thirty-fourth or thirty-fifth aspect of the invention, in the same manner.

In addition, the finish paper size is a paper size in a final format of a printed material. For example, the finish paper size is a paper size that can be finally obtained through a series of printing processes including a plate-making process, a prepress process such as plate making and imposition, a press process which is a printing process performed by a printing apparatus in the narrow sense, and post-press processes such as folding, cutting, or filing the printed paper. Hereinafter, these are applied to the printing support program according to the twelfth aspect of the invention, the storage medium according to the twenty-third aspect of the invention, and the printing support method according to the thirty-fourth or the thirty-fifth aspect of the invention, in the same manner.

In addition, the finish paper width is a paper width in the finish paper size, and the finish paper height is a paper height in the finish paper size. Hereinafter, these are applied to the printing support program according to the twelfth aspect of the invention, the storage medium according to the twenty-third aspect of the invention, and the printing support method according to the thirty-fourth or the thirty-fifth aspect of the invention, in the same manner.

In addition, the paper sizes of the entire pages of the document data are paper sizes each being assigned to each page of the document data. Hereinafter, these are applied to the printing support program according to the twelfth aspect of the invention, the storage medium according to the twenty-third aspect of the invention, and the printing support method according to the thirty-fourth or the thirty-fifth aspect of the invention, in the same manner.

In addition, the paper width of the document data is a paper width in the paper size of the document data, and the paper height of the document data is a paper height in the paper size of the document data. Hereinafter, these are applied to the printing support program according to the twelfth aspect of the invention, the storage medium according to the twenty-third aspect of the invention, and the printing support method according to the thirty-fourth or the thirty-fifth aspect of the invention, in the same manner.

Moreover, in the document data, it is preferable to set paper width and paper height with respect to each of the plurality of pages. However, it may not be necessary to set the paper width and paper height with respect to each of the plurality of pages. For example, paper width and paper height with respect to two pages of ten pages may be set. Hereinafter, these are applied to the printing support program according to the twelfth aspect of the invention, the storage medium according to the twenty-third aspect of the invention, and the printing support method according to the thirty-fourth or the thirty-fifth aspect of the invention, in the same manner.

Furthermore, a method of acquiring the finish paper size information includes, for example, a method of acquiring the finish paper size information from description of an electronic job ticket and a method of acquiring the finish paper size information from a user's express input through a user interface. Hereinafter, these are applied to the printing support program according to the twelfth aspect of the invention, the storage medium according to the twenty-third aspect of the invention, and the printing support method according to the thirty-fourth or the thirty-fifth aspect of the invention, in the same manner.

In addition, a method of processing the document data includes, for example, a method of rotating page data of document data (in the unit of 90°), a method of enlarging or reducing page data of document data, and a method of dividing a single page of document data into a plurality of pages. Hereinafter, these are applied to the printing support program according to the twelfth aspect of the invention, the storage medium according to the twenty-third aspect of the invention, and the printing support method according to the thirty-fourth or the thirty-fifth aspect of the invention, in the same manner.

Furthermore, the normalization rule storage unit stores the normalization rules in all units and at all time. In addition, the normalization rule storage unit may store the normalization rules in advance, or may store the normalization rules, for example, by an external input when a system operates, without storing the normalization rules in advance. Hereinafter, these are applied to the printing support program according to the twelfth aspect of the invention, the storage medium according to the twenty-third aspect of the invention, and the printing support method according to the thirty-fourth or the thirty-fifth aspect of the invention, in the same manner.

In addition, this system may be implemented by using a single device or terminal or other apparatuses, or may be implemented as a network system in which a plurality of devices, terminals, and other apparatuses are communicably connected to one another. In the latter case, each constituent component may be included in any of the plurality of apparatuses if the constituent components are communicably connected to one another.

Further, according to a second aspect of the invention, in the printing support system according to the first aspect of the invention, preferably, the finish paper size information acquisition unit acquires, as the finish paper size information, paper width and paper height of a front page of the document data acquired by the document data acquisition unit.

In the configuration described above, since the finish paper size information acquisition unit acquires, as the finish paper size information, the paper width and paper height of a front page of the acquired document data, the document data is processed to be adapted to the paper width and paper height of the first page of the document data.

Furthermore, according to a third aspect of the invention, in the printing support system according to the first aspect of the invention, preferably, the finish paper size information acquisition unit acquires, as the finish paper size information, paper width and paper height of a page, of which paper width and paper height are minimum, of the document data acquired by the document data acquisition unit.

In the configuration described above, since the finish paper size information acquisition unit acquires, as the finish paper size information, the paper width and paper height of a page, of which paper width and paper height are minimum, of the acquired document data, the document data is processed to be adapted to the paper, of which paper width and paper height are minimum, of the document data.

Furthermore, according to a fourth aspect of the invention, in the printing support system according to the first aspect of the invention, preferably, the normalization rule storage unit stores, as the normalization rule, at least a width-direction page division rule by which a page of the document data is divided into ‘N’ (‘N’ is an integer equal to or larger than 2) equal parts in the paper width direction, the normalization rule selection unit selects the width-direction page division rule in the normalization rule storage unit if it is determined that a paper width of the page of the document data is ‘N’ times the finish paper width and a paper height of the page of the document data is equal to the finish paper height, and the document data processing unit processes the page of the document data on the basis of the width-direction page division rule selected by the normalization rule selection unit.

In the configuration described above, if it is determined that the paper width of the page of the document data is ‘N’ times the finish paper width and the paper height of the page of the document data is equal to the finish paper height, the width-direction page division rule is selected by the normalization rule selection unit. Then, the page of the document data is processed by the document data processing unit on the basis of the selected width-direction page division rule.

Thus, it is possible to process the page, of which the paper width is ‘N’ times the finish paper width and the paper height is equal to the finish paper height, of the document data, so as to be visually good.

Here, the ‘equal’ when comparing the paper width or the paper height of the page of the document data with the finish paper width or the finish paper height does not necessarily mean that a value of the paper width or the paper height completely matches a value of the finish paper width or the finish paper height. For example, even though the value of the paper width or the paper height does not completely match the value of the finish paper width or the finish paper height, it may be determined to be ‘equal’ if a difference between the value of the paper width or the paper height and the value of the finish paper width or the finish paper height is in the range of ±5% of the value of the finish paper width or the finish paper height. The above concept of the ‘equal’ is applied to a printing support system according to any one of sixth, seventh, eighth, and tenth aspects of the invention, in the same manner.

Furthermore, according to a fifth aspect of the invention, in the printing support system according to the first aspect of the invention, preferably, the normalization rule storage unit stores, as the normalization rule, at least a height-direction page division rule by which a page of the document data is divided into ‘M’ (‘M’ is an integer equal to or larger than 2) equal parts in the paper height direction, the normalization rule selection unit selects the height-direction page division rule in the normalization rule storage unit if it is determined that a paper height of the page of the document data is ‘M’ times the finish paper height and a paper width of the page of the document data is equal to the finish paper width, and the document data processing unit processes the page of the document data on the basis of the height-direction page division rule selected by the normalization rule selection unit.

In the configuration described above, if it is determined that the paper height of the page of the document data is ‘M’ times the finish paper height and the paper width of the page of the document data is equal to the finish paper width, the height-direction page division rule is selected by the normalization rule selection unit. Then, the page of the document data is processed by the document data processing unit on the basis of the selected height-direction page division rule.

Thus, It is possible to process the page, of which the paper height is ‘M’ times the finish paper height and the paper width is equal to the finish paper width, of the document data, so as to be visually good.

Furthermore, according to a sixth aspect of the invention, in the printing support system according to the first aspect of the invention, preferably, the normalization rule storage unit stores, as the normalization rule, at least a page enlargement/reduction rule by which a page of the document data is enlarged or reduced in accordance with the finish paper width and the finish paper height, the normalization rule selection unit selects the page enlargement/reduction rule in the normalization rule storage unit if it is determined that a ratio between a paper width of the page of the document data and the finish paper width is equal to a ratio between a paper height of the page of the document data and the finish paper height, and the document data processing unit processes the page of the document data on the basis of the page enlargement/reduction rule selected by the normalization rule selection unit.

In the configuration described above, if it is determined that a ratio between the paper width of the page of the document data and the finish paper width is equal to a ratio between the paper height of the page of the document data and the finish paper height, the page enlargement/reduction rule is selected by the normalization rule selection unit. Then, the page of the document data is processed by the document data processing unit on the basis of the selected page enlargement/reduction rule.

Thus, it is possible to process a page so as to be visually good, a ratio between the paper width of the page of the document data and the finish paper width being equal to a ratio between the paper height of the page of the document data and the finish paper height.

Furthermore, according to a seventh aspect of the invention, in the printing support system according to the first aspect of the invention, preferably, the normalization rule storage unit stores, as the normalization rule, at least a page rotation rule by which a page of the document data is rotated 90° or −90°, the normalization rule selection unit selects the page rotation rule in the normalization rule storage unit if it is determined that a paper width of the page of the document data is equal to the finish paper height and a paper height of the page of the document data is equal to the finish paper width, and the document data processing unit processes the page of the document data on the basis of the page rotation rule selected by the normalization rule selection unit.

In the configuration described above, if it is determined that a paper width of the page of the document data is equal to the finish paper height and a paper height of the page of the document data is equal to the finish paper width, the page rotation rule is selected by the normalization rule selection unit. Then, the page of the document data is processed by the document data processing unit on the basis of the selected page rotation rule.

Thus, it is possible to process the page, of which the paper width is equal to the finish paper height and the paper height is equal to the finish paper width, of the document data, so as to be visually good.

Furthermore, according to an eighth aspect of the invention, in the printing support system according to the seventh aspect of the invention, preferably, a character direction determination unit that determines a direction of a character included in a page is further included, and the document data processing unit rotates the page of the document data on the basis of the direction of the character included in the page, which has been determined by the character direction determination unit, such that the character included in the page after the rotation is positioned upward or rightward as a result of having rotated the page of the document data.

In the configuration described above, the direction of a character included in a page is determined by the character direction determination unit. In addition, by the document data processing unit, the page of the document data is rotated on the basis of the determined direction of the character included in the page such that the character included in the page after the rotation is positioned upward or rightward as a result of having rotated the page of the document data.

Accordingly, since characters are positioned in the predetermined direction, it is possible to obtain a print result suitable for being cut for bookbinding and being page-folded.

Furthermore, according to a ninth aspect of the invention, in the printing support system according to the first aspect of the invention, preferably, the normalization rule storage unit stores, as the normalization rule, at least a page rotation and enlargement/reduction rule by which a page of the document data is rotated 90° or −90° and enlarged or reduced in accordance with the finish paper width and the finish paper height, the normalization rule selection unit selects the page rotation and enlargement/reduction rule in the normalization rule storage unit if it is determined that a ratio between a paper width of the page of the document data and the finish paper height is equal to a ratio between a paper height of the page of the document data and the finish paper width, and the document data processing unit processes the page of the document data on the basis of the page rotation and enlargement/reduction rule selected by the normalization rule selection unit.

In the configuration described above, if it is determined that a ratio between the paper width of the page of the document data and the finish paper height is equal to a ratio between the paper height of the page of the document data and the finish paper width, the page rotation and enlargement/reduction rule is selected by the normalization rule selection unit. Then, the page of the document data is processed by the document data processing unit on the basis of the selected page rotation and enlargement/reduction rule.

Thus, it is possible to process a page so as to be visually good, a ratio between the paper width of the page of the document data and the finish paper height being equal to a ratio between the paper height of the page of the document data and the finish paper width.

Furthermore, according to a tenth aspect of the invention, in the printing support system according to the first aspect of the invention, preferably, the normalization rule storage unit stores, as the normalization rule, at least an excess region trimming rule by which a part of a page region of the document data, which is not included in a region specified by the finish paper width and the finish paper height, is trimmed, the normalization rule selection unit selects the excess region trimming rule in the normalization rule storage unit if it is determined that both a difference between a paper width of the page of the document data and the finish paper width and a difference between a paper height of the page of the document data and the finish paper height are equal to or smaller than a predetermined value, and the document data processing unit processes the page of the document data on the basis of the excess region trimming rule selected by the normalization rule selection unit.

In the configuration described above, if it is determined that both a difference between the paper width of the page of the document data and the finish paper width and a difference between the paper height of the page of the document data and the finish paper height are equal to or smaller than a predetermined value, the excess region trimming rule is selected by the normalization rule selection unit. Then, the page of the document data is processed by the document data processing unit on the basis of the selected excess region trimming rule.

Thus, it is possible to process a page so as to be visually good, a difference between the paper width of the page of the document data and the finish paper width and a difference between the paper height of the page of the document data and the finish paper height being equal to or smaller than a predetermined value.

Furthermore, according to an eleventh aspect of the invention, in the printing support system according to the first aspect of the invention, it is preferable to further include an application identification information acquisition unit that acquires application identification information for identifying an application by which the document data has been created; a paper size correspondence information storage unit that stores the application identification information, paper width and paper height set by the application, and paper width and paper height after optimization in such a manner that the application identification information, the paper width and paper height set by the application, and the paper width and paper height after the optimization correspond to one another; and an optimized paper size search unit that searches, in the paper size correspondence information storage unit, the paper width and paper height after the optimization corresponding to the paper width and paper height of the document data acquired by the document data acquisition unit and the application identification information acquired by the application identification information acquisition unit. In addition, preferably, the normalization rule selection unit selects the normalization rules in the normalization rule storage unit on the basis of the paper width and paper height after the optimization searched by the optimized paper size search unit and the finish paper width and finish paper height of the finish paper size information acquired by the finish paper size information acquisition unit.

In the configuration described above, the application identification information is acquired by the application identification information acquisition unit. In addition, by the optimized paper size search unit, the paper width and paper height after the optimization corresponding to the paper width and paper height of the document data and the application identification information that have been acquired is searched in the paper size correspondence information storage unit. As a result, when the corresponding paper size is searched, the normalization rules are selected by the normalization rule selection unit on the basis of the paper width and paper height after the optimization that has been searched and the finish paper width and finish paper height of the finish paper size information that has been acquired.

Thus, even in the case when the settings for indicating the same paper size are different according to applications, the processing can be properly performed.

Here, the paper size correspondence information storage unit stores the paper size correspondence information in all units and at all time. In addition, the paper size correspondence information storage unit may store the paper size correspondence information in advance, or may store the paper size correspondence information, for example, by an external input when a system operates, without storing the paper size correspondence information in advance. Hereinafter, these are applied to a printing support program according to a twenty-second aspect of the invention, a storage medium according to a thirty-third aspect of the invention, and a printing support method according to a forty-fifth aspect of the invention, in the same manner.

In addition, according to a twelfth aspect of the invention, a printing support program that supports performing a printing process on the basis of document data allowing paper width and paper height to be set for each of a plurality of pages causes a computer to execute: acquiring the document data; acquiring finish paper size information indicating finish paper width and finish paper height of a printed material; selecting a normalization rule in a normalization rule storage unit, which stores a plurality of normalization rules used to process the document data such that paper widths and paper heights of entire pages of the document data are adapted to the finish paper width and finish paper height of the finish paper size information, on the basis of the paper width and paper height of the document data acquired in the acquiring of the document data and the finish paper width and finish paper height of the finish paper size information acquired in the acquiring of the finish paper size information; and processing the document data acquired in the acquiring of the document data on the basis of the normalization rule selected in the selecting of the normalization rule.

In the configuration described above, by causing a computer to read out a program and then to perform processing according to the read program, it is possible to obtain the same operation and effect as in the printing support system according to the first aspect of the invention.

Furthermore, according to a thirteenth aspect of the invention, in the printing support program according to the twelfth aspect of the invention, preferably, in the acquiring of the finish paper size information acquires, paper width and paper height of a front page of the document data acquired in the acquiring of the document data are acquired as the finish paper size information.

In the configuration described above, by causing a computer to read out a program and then to perform processing according to the read program, it is possible to obtain the same operation and effect as in the printing support system according to the second aspect of the invention.

Furthermore, according to a fourteenth aspect of the invention, in the printing support program according to the twelfth aspect of the invention, preferably, in the acquiring of the finish paper size information acquires, paper width and paper height of a page, of which paper width and paper height are minimum, of the document data acquired in the acquiring of the document data are acquired as the finish paper size information.

In the configuration described above, by causing a computer to read out a program and then to perform processing according to the read program, it is possible to obtain the same operation and effect as in the printing support system according to the third aspect of the invention.

Furthermore, according to a fifteenth aspect of the invention, in the printing support program according to the twelfth aspect of the invention, preferably, the normalization rule storage unit stores, as the normalization rule, at least a width-direction page division rule by which a page of the document data is divided into ‘N’ (‘N’ is an integer equal to or larger than 2) equal parts in the paper width direction. In addition, preferably, in the selecting of the normalization rule, the width-direction page division rule is selected in the normalization rule storage unit if it is determined that a paper width of the page of the document data is ‘N’ times the finish paper width and a paper height of the page of the document data is equal to the finish paper height, and in the processing of the document data, the page of the document data is processed on the basis of the width-direction page division rule selected in the selecting of the normalization rule.

In the configuration described above, by causing a computer to read out a program and then to perform processing according to the read program, it is possible to obtain the same operation and effect as in the printing support system according to the fourth aspect of the invention.

Furthermore, according to a sixteenth aspect of the invention, in the printing support program according to the twelfth aspect of the invention, preferably, the normalization rule storage unit stores, as the normalization rule, at least a height-direction page division rule by which a page of the document data is divided into ‘M’ (‘M’ is an integer equal to or larger than 2) equal parts in the paper height direction. In addition, preferably, in the selecting of the normalization rule, the height-direction page division rule is selected in the normalization rule storage unit if it is determined that a paper height of the page of the document data is ‘M’ times the finish paper height and a paper width of the page of the document data is equal to the finish paper width, and in the processing of the document data, the page of the document data is processed on the basis of the height-direction page division rule selected in the selecting of the normalization rule.

In the configuration described above, by causing a computer to read out a program and then to perform processing according to the read program, it is possible to obtain the same operation and effect as in the printing support system according to the fifth aspect of the invention.

Furthermore, according to a seventeenth aspect of the invention, in the printing support program according to the twelfth aspect of the invention, preferably, the normalization rule storage unit stores, as the normalization rule, at least a page enlargement/reduction rule by which a page of the document data is enlarged or reduced in accordance with the finish paper width and the finish paper height. In addition, preferably, in the selecting of the normalization rule, the page enlargement/reduction rule is selected in the normalization rule storage unit if it is determined that a ratio between a paper width of the page of the document data and the finish paper width is equal to a ratio between a paper height of the page of the document data and the finish paper height, and in the processing of the document data, the page of the document data is processed on the basis of the page enlargement/reduction rule selected in the selecting of the normalization rule.

In the configuration described above, by causing a computer to read out a program and then to perform processing according to the read program, it is possible to obtain the same operation and effect as in the printing support system according to the sixth aspect of the invention.

Furthermore, according to an eighteenth aspect of the invention, in the printing support program according to the twelfth aspect of the invention, preferably, the normalization rule storage unit stores, as the normalization rule, at least a page rotation rule by which a page of the document data is rotated 90° or −90°. In addition, preferably, in the selecting of the normalization rule, the page rotation rule is selected in the normalization rule storage unit if it is determined that a paper width of the page of the document data is equal to the finish paper height and a paper height of the page of the document data is equal to the finish paper width, and in the processing of the document data, the page of the document data is processed on the basis of the page rotation rule selected in the selecting of the normalization rule.

In the configuration described above, by causing a computer to read out a program and then to perform processing according to the read program, it is possible to obtain the same operation and effect as in the printing support system according to the seventh aspect of the invention.

Furthermore, according to a nineteenth aspect of the invention, in the printing support program according to the eighteenth aspect of the invention, it is preferable to include a program causing a computer to execute determining a direction of a character included in a page. In addition, preferably, in the processing of the document data, the page of the document data is rotated on the basis of the direction of the character included in the page, which has been determined in the determining of the direction of the character included in the page, such that the character included in the page after the rotation is positioned upward or rightward as a result of having rotated the page of the document data.

In the configuration described above, by causing a computer to read out a program and then to perform processing according to the read program, it is possible to obtain the same operation and effect as in the printing support system according to the eighth aspect of the invention.

Furthermore, according to a twentieth aspect of the invention, in the printing support program according to the twelfth aspect of the invention, preferably, the normalization rule storage unit stores, as the normalization rule, at least a page rotation and enlargement/reduction rule by which a page of the document data is rotated 9° or −90° and enlarged or reduced in accordance with the finish paper width and the finish paper height. In addition, preferably, in the selecting of the normalization rule, the page rotation and enlargement/reduction rule is selected in the normalization rule storage unit if it is determined that a ratio between a paper width of the page of the document data and the finish paper height is equal to a ratio between a paper height of the page of the document data and the finish paper width, and in the processing of the document data, the page of the document data is processed on the basis of the page rotation and enlargement/reduction rule selected in the selecting of the normalization rule.

In the configuration described above, by causing a computer to read out a program and then to perform processing according to the read program, it is possible to obtain the same operation and effect as in the printing support system according to the ninth aspect of the invention.

Furthermore, according to a twenty-first aspect of the invention, in the printing support program according to the twelfth aspect of the invention, preferably, the normalization rule storage unit stores, as the normalization rule, at least an excess region trimming rule by which a part of a page region of the document data, which is not included in a region specified by the finish paper width and the finish paper height, is trimmed. In addition, preferably, in the selecting of the normalization rule, the excess region trimming rule is selected in the normalization rule storage unit if it is determined that both a difference between a paper width of the page of the document data and the finish paper width and a difference between a paper height of the page of the document data and the finish paper height are equal to or smaller than a predetermined value, and in the processing of the document data, the page of the document data is processed on the basis of the excess region trimming rule selected in the selecting of the normalization rule.

In the configuration described above, by causing a computer to read out a program and then to perform processing according to the read program, it is possible to obtain the same operation and effect as in the printing support system according to the tenth aspect of the invention.

Furthermore, according to a twenty-second aspect of the invention, in the printing support program according to the twelfth aspect of the invention, it is preferable to include a program causing a computer to execute: acquiring application identification information for identifying an application by which the document data has been created; and searching, in a paper size correspondence information storage unit that stores the application identification information, paper width and paper height set by the application, and paper width and paper height after optimization in such a manner that the application identification information, the paper width and paper height set by the application, and the paper width and paper height after the optimization correspond to one another, the paper width and paper height after the optimization corresponding to the paper width and paper height of the document data acquired in the acquiring of the document data and the application identification information acquired in the acquiring of the application identification information. In addition, preferably, in the selecting of the normalization rule, the normalization rules is selected in the normalization rule storage unit on the basis of the paper width and paper height after the optimization searched in the searching of the normalization rule and the finish paper width and finish paper height of the finish paper size information acquired in the acquiring of the finish paper size information.

In the configuration described above, by causing a computer to read out a program and then to perform processing according to the read program, it is possible to obtain the same operation and effect as in the printing support system according to the eleventh aspect of the invention.

In addition, according to a twenty-third aspect of the invention, a computer-readable storage medium storing a printing support program that supports performing a printing process on the basis of document data allowing paper width and paper height to be set for each of a plurality of pages includes a program causing a computer to execute: acquiring the document data; acquiring finish paper size information indicating finish paper width and finish paper height of a printed material; selecting a normalization rule in a normalization rule storage unit, which stores a plurality of normalization rules used to process the document data such that paper widths and paper heights of entire pages of the document data are adapted to the finish paper width and finish paper height of the finish paper size information, on the basis of the paper width and paper height of the document data acquired in the acquiring of the document data and the finish paper width and finish paper height of the finish paper size information acquired in the acquiring of the finish paper size information; and processing the document data acquired in the acquiring of the document data on the basis of the normalization rule selected in the selecting of the normalization rule.

In the configuration described above, by causing a computer to read out a program from a storage medium and to perform processing according to the read program, it is possible to obtain the same operation and effect as in the printing support system according to the first aspect of the invention.

Furthermore, according to a twenty-fourth aspect of the invention, in the storage medium according to the twenty-third aspect of the invention, preferably, in the acquiring of the finish paper size information acquires, paper width and paper height of a front page of the document data acquired in the acquiring of the document data are acquired as the finish paper size information.

In the configuration described above, by causing a computer to read out a program from a storage medium and to perform processing according to the read program, it is possible to obtain the same operation and effect as in the printing support system according to the second aspect of the invention.

Furthermore, according to a twenty-fifth aspect of the invention, in the storage medium according to the twenty-third aspect of the invention, preferably, in the acquiring of the finish paper size information acquires, paper width and paper height of a page, of which paper width and paper height are minimum, of the document data acquired in the acquiring of the document data are acquired as the finish paper size information.

In the configuration described above, by causing a computer to read out a program from a storage medium and to perform processing according to the read program, it is possible to obtain the same operation and effect as in the printing support system according to the third aspect of the invention.

Furthermore, according to a twenty-sixth aspect of the invention, in the storage medium according to the twenty-third aspect of the invention, preferably, the normalization rule storage unit stores, as the normalization rule, at least a width-direction page division rule by which a page of the document data is divided into ‘N’ (‘N’ is an integer equal to or larger than 2) equal parts in the paper width direction. In addition, preferably, in the selecting of the normalization rule, the width-direction page division rule is selected in the normalization rule storage unit if it is determined that a paper width of the page of the document data is ‘N’ times the finish paper width and a paper height of the page of the document data is equal to the finish paper height, and in the processing of the document data, the page of the document data is processed on the basis of the width-direction page division rule selected in the selecting of the normalization rule.

In the configuration described above, by causing a computer to read out a program from a storage medium and to perform processing according to the read program, it is possible to obtain the same operation and effect as in the printing support system according to the fourth aspect of the invention.

Furthermore, according to a twenty-seventh aspect of the invention, in the storage medium according to the twenty-third aspect of the invention, preferably, the normalization rule storage unit stores, as the normalization rule, at least a height-direction page division rule by which a page of the document data is divided into ‘M’ (‘M’ is an integer equal to or larger than 2) equal parts in the paper height direction. In addition, preferably, in the selecting of the normalization rule, the height-direction page division rule is selected in the normalization rule storage unit if it is determined that a paper height of the page of the document data is ‘M’ times the finish paper height and a paper width of the page of the document data is equal to the finish paper width, and in the processing of the document data, the page of the document data is processed on the basis of the height-direction page division rule selected in the selecting of the normalization rule.

In the configuration described above, by causing a computer to read out a program from a storage medium and to perform processing according to the read program, it is possible to obtain the same operation and effect as in the printing support system according to the fifth aspect of the invention.

Furthermore, according to a twenty-eighth aspect of the invention, in the storage medium according to the twenty-third aspect of the invention, preferably, the normalization rule storage unit stores, as the normalization rule, at least a page enlargement/reduction rule by which a page of the document data is enlarged or reduced in accordance with the finish paper width and the finish paper height. In addition, preferably, in the selecting of the normalization rule, the page enlargement/reduction rule is selected in the normalization rule storage unit if it is determined that a ratio between a paper width of the page of the document data and the finish paper width is equal to a ratio between a paper height of the page of the document data and the finish paper height, and in the processing of the document data, the page of the document data is processed on the basis of the page enlargement/reduction rule selected in the selecting of the normalization rule.

In the configuration described above, by causing a computer to read out a program from a storage medium and to perform processing according to the read program, it is possible to obtain the same operation and effect as in the printing support system according to the sixth aspect of the invention.

Furthermorer according to a twenty-ninth aspect of the invention, in the storage medium according to the twenty-third aspect of the invention, preferably, the normalization rule storage unit stores, as the normalization rule, at least a page rotation rule by which a page of the document data is rotated 90° or −90°. In addition, preferably, in the selecting of the normalization rule, the page rotation rule is selected in the normalization rule storage unit if it is determined that a paper width of the page of the document data is equal to the finish paper height and a paper height of the page of the document data is equal to the finish paper width, and in the processing of the document data, the page of the document data is processed on the basis of the page rotation rule selected in the selecting of the normalization rule.

In the configuration described above, by causing a computer to read out a program from a storage medium and to perform processing according to the read program, it is possible to obtain the same operation and effect as in the printing support system according to the seventh aspect of the invention.

Furthermore, according to a thirtieth aspect of the invention, in the storage medium according to the twenty-ninth aspect of the invention, it is preferable to include a program causing a computer to execute determining a direction of a character included in a page. In addition, preferably, in the processing of the document data, the page of the document data is rotated on the basis of the direction of the character included in the page, which has been determined in the determining of the direction of the character included in the page, such that the character included in the page after the rotation is positioned upward or rightward as a result of having rotated the page of the document data.

In the configuration described above, by causing a computer to read out a program from a storage medium and to perform processing according to the read program, it is possible to obtain the same operation and effect as in the printing support system according to the eighth aspect of the invention.

Furthermore, according to a thirty-first aspect of the invention, in the storage medium according to the twenty-third aspect of the invention, preferably, the normalization rule storage unit stores, as the normalization rule, at least a page rotation and enlargement/reduction rule by which a page of the document data is rotated 90° or −90° and enlarged or reduced in accordance with the finish paper width and the finish paper height. In addition, preferably, in the selecting of the normalization rule, the page rotation and enlargement/reduction rule is selected in the normalization rule storage unit if it is determined that a ratio between a paper width of the page of the document data and the finish paper height is equal to a ratio between a paper height of the page of the document data and the finish paper width, and in the processing of the document data, the page of the document data is processed on the basis of the page rotation and enlargement/reduction rule selected in the selecting of the normalization rule.

In the configuration described above, by causing a computer to read out a program from a storage medium and to perform processing according to the read program, it is possible to obtain the same operation and effect as in the printing support system according to the ninth aspect of the invention.

Furthermore, according to a thirty-second aspect of the invention, in the storage medium according to the twenty-third aspect of the invention, preferably, the normalization rule storage unit stores, as the normalization rule, at least an excess region trimming rule by which a part of a page region of the document data, which is not included in a region specified by the finish paper width and the finish paper height, is trimmed. In addition, preferably, in the selecting of the normalization rule, the excess region trimming rule is selected in the normalization rule storage unit if it is determined that both a difference between a paper width of the page of the document data and the finish paper width and a difference between a paper height of the page of the document data and the finish paper height are equal to or smaller than a predetermined value, and in the processing of the document data, the page of the document data is processed on the basis of the excess region trimming rule selected in the selecting of the normalization rule.

In the configuration described above, by causing a computer to read out a program from a storage medium and to perform processing according to the read program, it is possible to obtain the same operation and effect as in the printing support system according to the tenth aspect of the invention.

Furthermore, according to a thirty-third aspect of the invention, in the storage medium according to the twenty-third aspect of the invention, it is preferable to include a program causing a computer to execute: acquiring application identification information for identifying an application by which the document data has been created; and searching an optimized paper size, in a paper size correspondence information storage unit that stores the application identification information, paper width and paper height set by the application, and paper width and paper height after optimization in such a manner that the application identification information, the paper width and paper height set by the application, and the paper width and paper height after the optimization correspond to one another, the paper width and paper height after the optimization corresponding to the paper width and paper height of the document data acquired in the acquiring of the document data and the application identification information acquired in the acquiring of the application identification information. In addition, preferably, in the selecting of the normalization rule, the normalization rules is selected in the normalization rule storage unit on the basis of the paper width and paper height after the optimization searched in the searching of the optimized paper size and the finish paper width and finish paper height of the finish paper size information acquired in the acquiring of the finish paper size information.

In the configuration described above, by causing a computer to read out a program from a storage medium and to perform processing according to the read program, it is possible to obtain the same operation and effect as in the printing support system according to the eleventh aspect of the invention.

In addition, according to a thirty-fourth aspect of the invention, a printing support method that supports performing a printing process on the basis of document data allowing paper width and paper height to be set for each of a plurality of pages includes: acquiring the document data; acquiring finish paper size information indicating finish paper width and finish paper height of a printed material; selecting a normalization rule in a normalization rule storage unit, which stores a plurality of normalization rules used to process the document data such that paper widths and paper heights of entire pages of the document data are adapted to the finish paper width and finish paper height of the finish paper size information, on the basis of the paper width and paper height of the document data acquired in the acquiring of the document data and the finish paper width and finish paper height of the finish paper size information acquired in the acquiring of the finish paper size information; and processing the document data acquired in the acquiring of the document data on the basis of the normalization rule selected in the selecting of the normalization rule.

Thus, it is possible to obtain the same effects as in the printing support system according to the first aspect of the invention.

In addition, according to a thirty-fifth aspect of the invention, a printing support method that supports performing a printing process on the basis of document data allowing paper width and paper height to be set for each of a plurality of pages includes: acquiring the document data by means of an operation unit; acquiring finish paper size information indicating finish paper width and finish paper height of a printed material by means of the operation unit; selecting a normalization rule in a normalization rule storage unit, which stores a plurality of normalization rules used to process the document data such that paper widths and paper heights of entire pages of the document data are adapted to the finish paper width and finish paper height of the finish paper size information, on the basis of the paper width and paper height of the document data acquired in the acquiring of the document data and the finish paper width and finish paper height of the finish paper size information acquired in the acquiring of the finish paper size information by means of the operation unit; and processing the document data acquired in the acquiring of the document data on the basis of the normalization rule selected in the selecting of the normalization rule by means of the operation unit.

Thus, it is possible to obtain the same effects as in the printing support system according to the first aspect of the invention.

Furthermore, according to a thirty-sixth aspect of the invention, in the printing support method according to the thirty-fourth aspect of the invention, preferably, in the acquiring of the finish paper size information acquires, paper width and paper height of a front page of the document data acquired in the acquiring of the document data are acquired as the finish paper size information.

Thus, it is possible to obtain the same effects as in the printing support system according to the second aspect of the invention.

Furthermore, according to a thirty-seventh aspect of the invention, in the printing support method according to the thirty-fourth aspect of the invention, preferably, in the acquiring of the finish paper size information acquires, paper width and paper height of a page, of which paper width and paper height are minimum, of the document data acquired in the acquiring of the document data are acquired as the finish paper size information.

Thus, it is possible to obtain the same effects as in the printing support system according to the third aspect of the invention.

Furthermore, according to a thirty-eighth aspect of the invention, in the printing support method according to the thirty-fourth aspect of the invention, preferably, the normalization rule storage unit stores, as the normalization rule, at least a width-direction page division rule by which a page of the document data is divided into ‘N’ (‘N’ is an integer equal to or larger than 2) equal parts in the paper width direction. In addition, preferably, in the selecting of the normalization rule, the width-direction page division rule is selected in the normalization rule storage unit if it is determined that a paper width of the page of the document data is ‘N’ times the finish paper width and a paper height of the page of the document data is equal to the finish paper height, and in the processing of the document data, the page of the document data is processed on the basis of the width-direction page division rule selected in the selecting of the normalization rule.

Thus, it is possible to obtain the same effects as in the printing support system according to the fourth aspect of the invention.

Furthermore, according to a thirty-ninth aspect of the invention, in the printing support method according to the thirty-fourth aspect of the invention, preferably, the normalization rule storage unit stores, as the normalization rule, at least a height-direction page division rule by which a page of the document data is divided into ‘M’ (‘M’ is an integer equal to or larger than 2) equal parts in the paper height direction. In addition, preferably, in the selecting of the normalization rule, the height-direction page division rule is selected in the normalization rule storage unit if it is determined that a paper height of the page of the document data is ‘M’ times the finish paper height and a paper width of the page of the document data is equal to the finish paper width, and in the processing of the document data, the page of the document data is processed on the basis of the height-direction page division rule selected in the selecting of the normalization rule.

Thus, it is possible to obtain the same effects as in the printing support system according to the fifth aspect of the invention.

Furthermore, according to a fortieth aspect of the invention, in the printing support method according to the thirty-fourth aspect of the invention, preferably, the normalization rule storage unit stores, as the normalization rule, at least a page enlargement/reduction rule by which a page of the document data is enlarged or reduced in accordance with the finish paper width and the finish paper height. In addition, preferably, in the selecting of the normalization rule, the page enlargement/reduction rule is selected in the normalization rule storage unit if it is determined that a ratio between a paper width of the page of the document data and the finish paper width is equal to a ratio between a paper height of the page of the document data and the finish paper height, and in the processing of the document data, the page of the document data is processed on the basis of the page enlargement/reduction rule selected in the selecting of the normalization rule.

Thus, it is possible to obtain the same effects as in the printing support system according to the sixth aspect of the invention.

Furthermore, according to a forty-first aspect of the invention, in the printing support method according to the thirty-fourth aspect of the invention, preferably, the normalization rule storage unit stores, as the normalization rule, at least a page rotation rule by which a page of the document data is rotated 90° or −90°. In addition, preferably, in the selecting of the normalization rule, the page rotation rule is selected in the normalization rule storage unit if it is determined that a paper width of the page of the document data is equal to the finish paper height and a paper height of the page of the document data is equal to the finish paper width and in the processing of the document data, the page of the document data is processed on the basis of the page rotation rule selected in the selecting of the normalization rule.

Thus, it is possible to obtain the same effects as in the printing support system according to the seventh aspect of the invention.

Furthermore, according to a forty-second aspect of the invention, in the printing support method according to the forth-first aspect of the invention, it is preferable to include determining a direction of a character included in a page. In addition, preferably, in the processing of the document data, the page of the document data is rotated on the basis of the direction of the character included in the page, which has been determined in the determining of the direction of the character included in the page, such that the character included in the page after the rotation is positioned upward or rightward as a result of having rotated the page of the document data.

Thus, it is possible to obtain the same effects as in the printing support system according to the eighth aspect of the invention.

Furthermore, according to a forty-third aspect of the invention, in the printing support method according to the thirty-fourth aspect of the invention, preferably, the normalization rule storage unit stores, as the normalization rule, at least a page rotation and enlargement/reduction rule by which a page of the document data is rotated 90° or −90° and enlarged or reduced in accordance with the finish paper width and the finish paper height. In addition, preferably, in the selecting of the normalization rule, the page rotation and enlargement/reduction rule is selected in the normalization rule storage unit if it is determined that a ratio between a paper width of the page of the document data and the finish paper height is equal to a ratio between a paper height of the page of the document data and the finish paper width, and in the processing of the document data, the page of the document data is processed on the basis of the page rotation and enlargement/reduction rule selected in the selecting of the normalization rule.

Thus, it is possible to obtain the same effects as in the printing support system according to the ninth aspect of the invention.

Furthermore, according to a forty-fourth aspect of the invention, in the printing support method according to the thirty-fourth aspect of the invention, preferably, the normalization rule storage unit stores, as the normalization rule, at least an excess region trimming rule by which a part of a page region of the document data, which is not included in a region specified by the finish paper width and the finish paper height, is trimmed. In addition, preferably, in the selecting of the normalization rule, the excess region trimming rule is selected in the normalization rule storage unit if it is determined that both a difference between a paper width of the page of the document data and the finish paper width and a difference between a paper height of the page of the document data and the finish paper height are equal to or smaller than a predetermined value, and in the processing of the document data, the page of the document data is processed on the basis of the excess region trimming rule selected in the selecting of the normalization rule.

Thus, it is possible to obtain the same effects as in the printing support system according to the tenth aspect of the invention.

Furthermore, according to a forty-fifth aspect of the invention, in the printing support method according to the thirty-fourth aspect of the invention, it is preferable to include: acquiring application identification information for identifying an application by which the document data has been created; and searching an optimized paper size, in a paper size correspondence information storage unit that stores the application identification information, paper width and paper height set by the application, and paper width and paper height after optimization in such a manner that the application identification information, the paper width and paper height set by the application, and the paper width and paper height after the optimization correspond to one another, the paper width and paper height after the optimization corresponding to the paper width and paper height of the document data acquired in the acquiring of the document data and the application identification information acquired in the acquiring of the application identification information. In addition, preferably, in the selecting of the normalization rule, the normalization rules is selected in the normalization rule storage unit on the basis of the paper width and paper height after the optimization searched in the searching of the optimized paper size and the finish paper width and finish paper height of the finish paper size information acquired in the acquiring of the finish paper size information.

Thus, it is possible to obtain the same effects as in the printing support system according to the eleventh aspect of the invention.

### BRIEF DESCRIPTION OF THE DRAWINGS

The invention will be described with reference to the accompanying drawings, wherein like numbers reference like elements.

FIG. 1 is a functional block diagram illustrating a functional outline of a network system.

FIG. 2 is a view illustrating the hardware configuration of a host terminal 100.

FIG. 3 is a view illustrating the data structure of document data.

FIG. 4 is a view illustrating the data structure of a print-specification electronic job ticket.

FIG. 5 is a view illustrating the data structure of a normalization rule.

FIG. 6 is a view illustrating a method of processing document data on the basis of a width-direction page division rule.

FIG. 7 is a view illustrating a method of processing document data on the basis of a height-direction page division rule.

FIG. 8 is a view illustrating a method of processing document data on the basis of a page enlargement/reduction rule.

FIG. 9 is a view illustrating a method of processing document data on the basis of a page rotation rule.

FIG. 10 is a view illustrating a method of processing document data on the basis of a page rotation and enlargement/reduction rule.

FIG. 11 is a view illustrating a method of processing document data on the basis of an excess region trimming rule.

FIG. 12 is a view illustrating a method of processing document data on the basis of an aspect-ratio-fixed page enlargement/reduction rule.

FIG. 13 is a view illustrating the data structure of paper size correspondence information table 400.

FIG. 14 is a view illustrating the data structure of a print-setting electronic job ticket.

FIG. 15 is a flow chart illustrating a print request process.

FIG. 16 is a view illustrating an example in which four pages are imposed on each of both sides of a piece of paper.

FIG. 17 is a view illustrating a setting example of a paper folding direction.

FIG. 18 is a view illustrating a sequence of folding paper.

FIG. 19 is a view illustrating the data structure of document data before processing is performed.

FIG. 20 is a view illustrating the data structure of document data after processing is performed.

FIG. 21 is a flow chart illustrating processing procedures.

FIG. 22 is a view illustrating the data structure of a processing command.

FIG. 23 is a view illustrating a method of processing document data on the basis of a processing command.

FIG. 24 is a view illustrating the data structure of a normalization rule.

FIG. 25 is a view illustrating the data structure of a normalization rule.

FIG. 26A is a view illustrating the data structure of a normalization rule.

FIG. 26B is a view illustrating the data structure of a normalization rule.

FIG. 27 is a view illustrating a storage medium and the data structure thereof.

### DESCRIPTION OF EXEMPLARY EMBODIMENTS

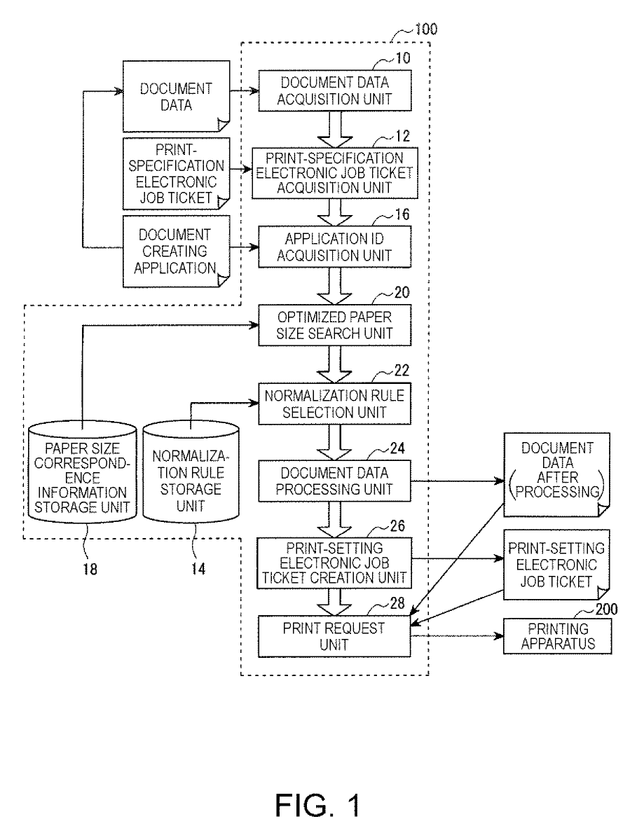

Hereinafter, an embodiment of the invention will be described with reference to the accompanying drawings. FIGS. 1 to 20 are views illustrating a printing support system, a printing support program, a storage medium, and a printing support method according to the embodiment of the invention.

In the present embodiment, the printing support system, the printing support program, the storage medium, and the printing support method are applied to a case in which a printing apparatus 200 performs a printing process by using a print-specification electronic job ticket, as shown in FIG. 1.

First, a functional outline of a network system to which the invention is applied will be described.

FIG. 1 is a functional block diagram illustrating the functional outline of the network system.

As shown in FIG. 1, a host terminal 100 and the printing apparatus 200 are connected to a network 199.

The host terminal 100 includes: a document data acquisition unit 10 that acquires document data in which a paper width and a paper height can be set for each page; a print-specification electronic job ticket acquisition unit 12 that acquires a print-specification electronic job ticket including a finish paper width and a finish paper height of a printed material; and a normalization rule storage unit 14 that stores a plurality of normalization rules that is used to process the document data such that the paper width and paper height of entire pages of the document data are adapted to the finish paper width and finish paper height of the print-specification electronic job ticket.

Further, the host terminal 100 includes: an application ID acquisition unit 16 that acquires an application ID for identifying an application by which the document data has been created; a paper size correspondence information storage unit 18 that stores the application ID, paper width and paper height set by the application, and paper width and paper height after optimization in such a manner that the application ID, the paper width and paper height set by the application, and the paper width and paper height after optimization correspond to one another; and an optimized paper size search unit 20 that searches, in the paper size correspondence information storage unit 18, the paper width and paper height after the optimization corresponding to the paper width and paper height of the document data acquired by the document data acquisition unit 10 and the application ID acquired by the application ID acquisition unit 16.

Furthermore, the host terminal 100 includes: a normalization rule selection unit 22 that selects a normalization rule in the normalization rule storage unit 14 on the basis of the paper width and paper height after optimization detected by the optimized paper size search unit 20 and the finish paper width and finish paper height of the print-specification electronic job ticket acquired by the print-specification electronic job ticket acquisition unit 12; and a document data processing unit 24 that processes the document data acquired by the document data acquisition unit 10 on the basis of the normalization rule selected by the normalization rule selection unit 22.

In addition, the host terminal 100 includes: a print-setting electronic job ticket creation unit 26 that creates a print-setting electronic job ticket including a print setting of the printing apparatus 200 on the basis of the print-specification electronic job ticket acquired in the print-specification electronic job ticket acquisition unit 12; and a print request unit 28 that requests the printing apparatus 200 to perform a print process on the basis of the print-setting electronic job ticket created by the print-setting electronic job ticket creation unit 26 and the document data processed by the document data processing unit 24.

Next, the configuration of the host terminal 100 will be described in detail.

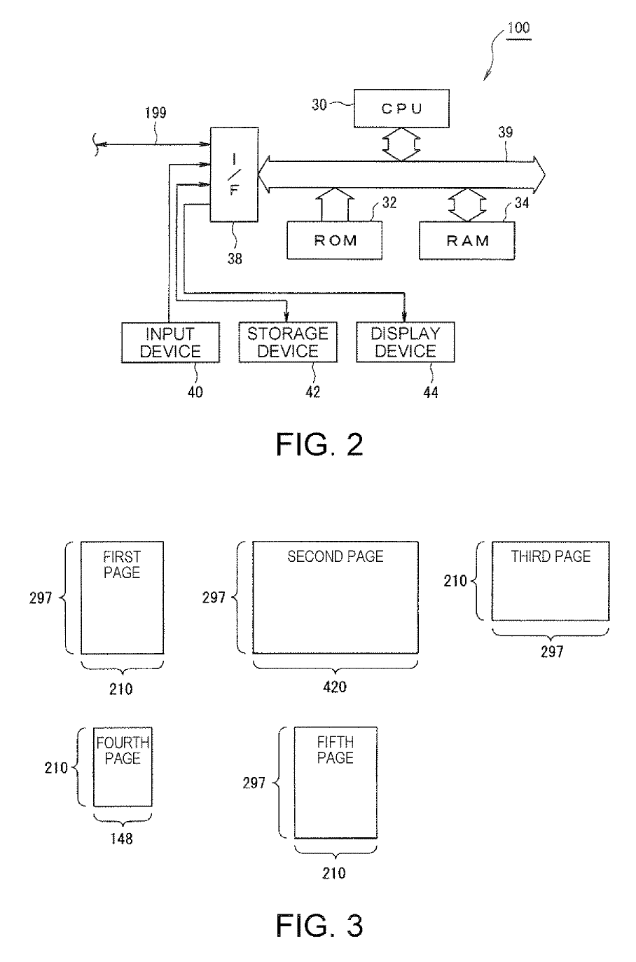

FIG. 2 is a view illustrating the hardware configuration of the host terminal 100.

As shown in FIG. 2, the host terminal 100 includes a CPU 30 that controls an overall system and operations on the basis of a control program, a ROM 32 that stores, for example, the control program of the CPU 30 in a predetermined region, a RAM 34 that stores data read from the ROM 32 or an operation result needed during an operation process of the CPU 30, and an I/F 38 through which data is input/output with respect to an external device. Data transmission among the CPU 30, the ROM 32, the RAM 34, and the I/F 38 is performed through a bus 39 which is a signal line provided to transmit data.

An input device 40, such as a keyboard or a mouse serving as a human interface unit, by which data can be input, a storage device 42 that stores data, tables, or the like as a file, a display device 44 that displays a screen on the basis of an image signal, and a signal line for connection with a network 199, which are all external devices, are connected to the I/F 38.

Next, a data structure of document data will be described.

FIG. 3 is a view illustrating the data structure of the document data.

As shown in FIG. 3, document data is composed of, for example, a PDF file. In addition, in the page data, it is possible to set the paper width and paper height corresponding to each page. In an example shown in FIG. 3, the document data is composed of totally five pages, and paper widths and paper heights are differently set for respective pages. The paper width and paper height corresponding to each page is included as paper size information in the document data.

Next, a data structure of the print-specification electronic job ticket will be described.

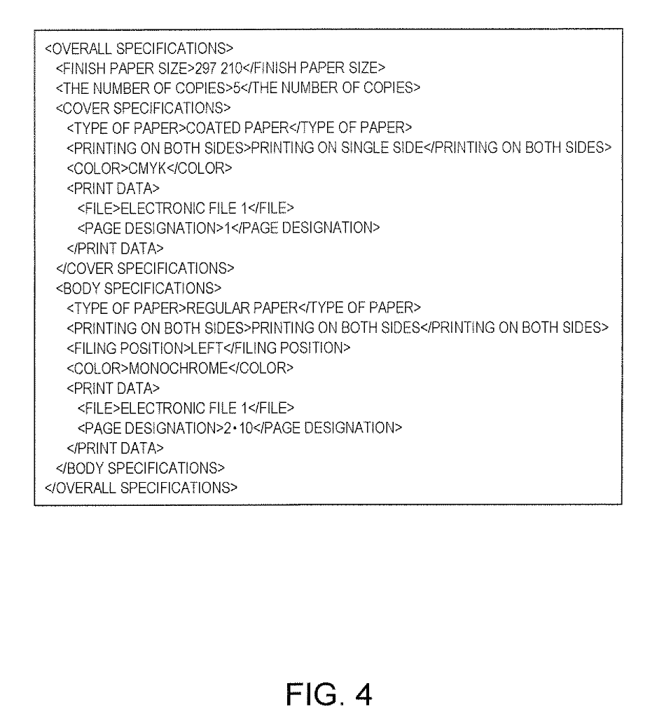

FIG. 4 is a view illustrating the data structure of the print-specification electronic job ticket.

The print-specification electronic job ticket is electronic data in which specifications of a printed material, such as the finish paper size, the number of copies to be printed, and a paper type are described. As shown in FIG. 4, in the print-specification electronic job ticket, print specifications are set by describing each tag set, which is composed of a start tag and an end tag, between a predetermined start tag (for example, <overall specifications>) and a predetermined end tag (for example, </overall specifications>). For example, the tag sets may be described by using a markup language, such as an XML (extensible Markup Language).

In the finish paper size, the finish paper width and finish paper height are specified. In the present embodiment, the finish paper size is required to process the page data, and the finish paper size may be acquired from the print-specification electronic job ticket or the paper size information of the document data. In the latter case in which the finish paper size may be acquired from the paper size information of the document data, it may be possible to acquire paper width and paper height of a predetermined page; however, it is preferable to acquire paper width and paper height of a front page or paper width and paper height of a page whose paper width and paper height are minimum.

The print-specification electronic job ticket does not include detailed setting on the printing apparatus 200 and information on the printing apparatus 200. In addition, document data is designated in the print-specification electronic job ticket. In this case, a plurality of document data items may be designated or only a specific page of document data may be designated.

Next, a data structure of a normalization rule will be described.

The storage device 42 is configured to include the normalization rule storage unit 14 and stores a plurality of normalization rules.

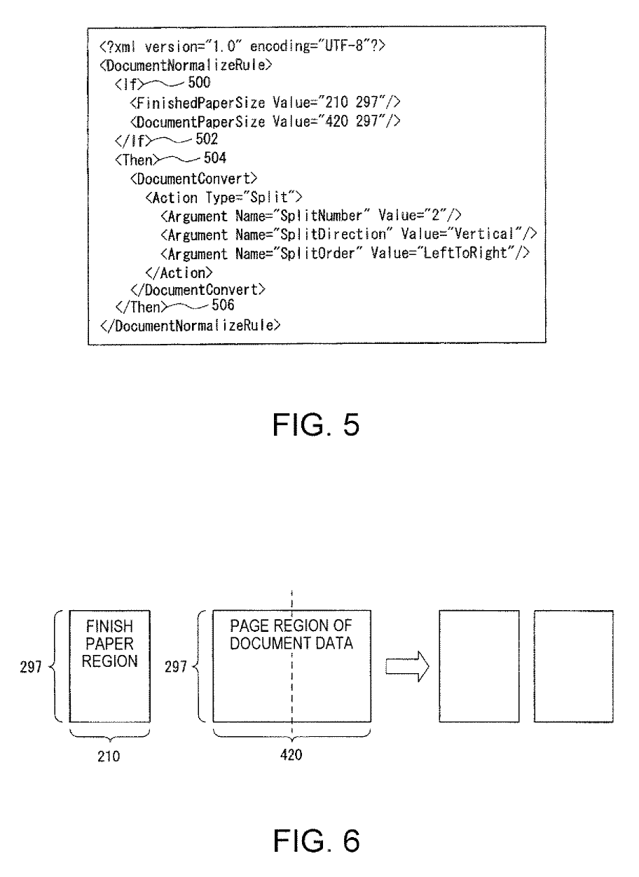

FIG. 5 is a view illustrating the data structure of the normalization rule.

The normalization rule is electronic data in which rules, by which data is processed such that the paper width and paper height of entire pages of the document data are adapted to the finish paper width and finish paper height of the print-specification electronic job ticket, are described. As shown in FIG. 5, in the normalization rule, the print specifications are set by describing each tag set, which is composed of a start tag and an end tag, between a predetermined start tag (for example, <DocumentNormalizeRule>) and a predetermined end tag (for example, </DocumentNormalizeRule>). For example, the tag sets may be described by using a markup language, such as an XML.

By a tag set 500 and 502, the relation between a document set paper size and a finish paper size is specified as a condition. In addition, by a tag set 504 and 506, a processing method performed in the case when a condition of the tag set 500 and 502 is satisfied is specified. An example shown in FIG. 5 indicates that when the finish paper size is (210, 297) (a first element indicates a width and a second element indicates a height; expressed in the same manner hereinbelow) and the document set paper size is (420, 297), the corresponding page is divided into two equal parts in the width direction of paper.

As the normalization rule, seven rules, which are a width-direction page division rule, a height-direction page division rule, a page enlargement/reduction rule, a page rotation rule, a page rotation and enlargement/reduction rule, an excess region trimming rule, and an aspect-ratio-fixed page enlargement/reduction rule, exist as shown in FIGS. 6 to 12. The data structure is the same as that shown in FIG. 5. Accordingly, with respect to each of the normalization rules described above, the relation between the document set paper size and the finish paper size and a processing method performed when the relation is satisfied will be described hereinafter.

FIG. 6 is a view illustrating a method of processing document data on the basis of the width-direction page division rule.

As shown in FIG. 6, the width-direction page division rule specifies that when a paper width of a page of document data is ‘N’ (‘N’ is an integer equal to or larger than 2) times a finish paper width and a paper height of the page of the document data is equal to a finish paper height, the page is divided into ‘N’ equal parts in the paper width direction.

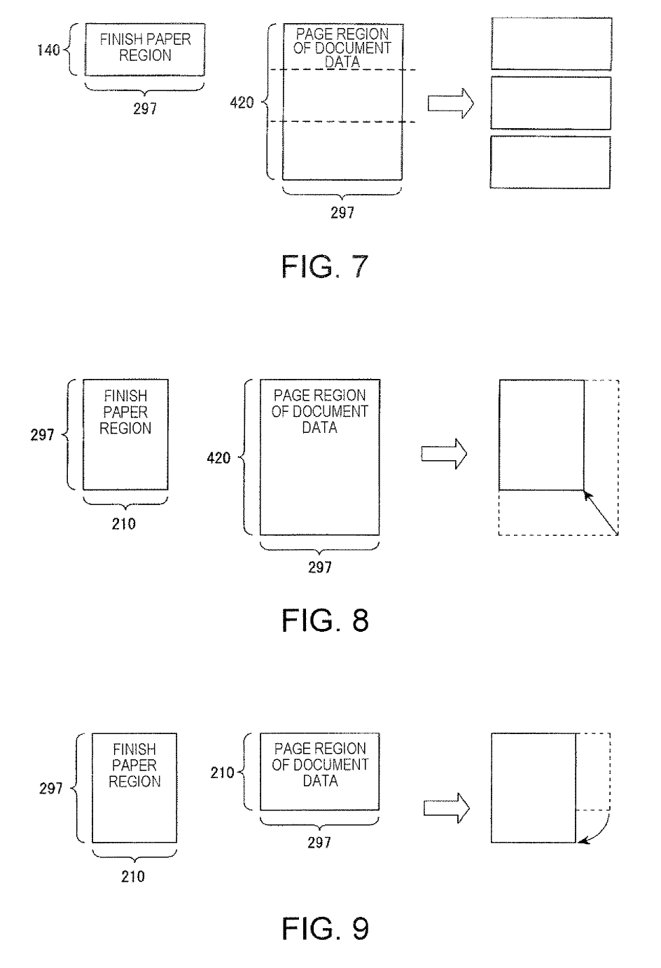

FIG. 7 is a view illustrating a method of processing document data on the basis of the height-direction page division rule.

As shown in FIG. 7, the height-direction page division rule specifies that when a paper height of a page of document data is ‘M’ (‘M’ is an integer equal to or larger than 2) times a finish paper height and a paper width of the page of the document data is equal to a finish paper width, the page is divided into ‘M’ equal parts in the paper height direction.

FIG. 8 is a view illustrating a method of processing document data on the basis of the page enlargement/reduction rule.

As shown in FIG. 8, the page enlargement/reduction rule specifies that when a ratio between a paper width of a page of document data and a finish paper width is equal to a ratio between a paper height of the page of the document data and a finish paper height, the page is enlarged or reduced in accordance with the finish paper size.

FIG. 9 is a view illustrating a method of processing document data on the basis of the page rotation rule.

As shown in FIG. 9, the page rotation rule specifies that when a paper width of a page of document data is equal to a finish paper height and a paper height of the page of the document data is equal to a finish paper width, the page is rotated 90° or −90°. In addition, it may be possible to rotate the page such that characters included in a page after the rotation are positioned upward or rightward as a result of the rotation, by using a unit that determines the direction of characters in the document data, for example, a software library capable of analyzing details of the PDF in the case when the document data is a PDF file.

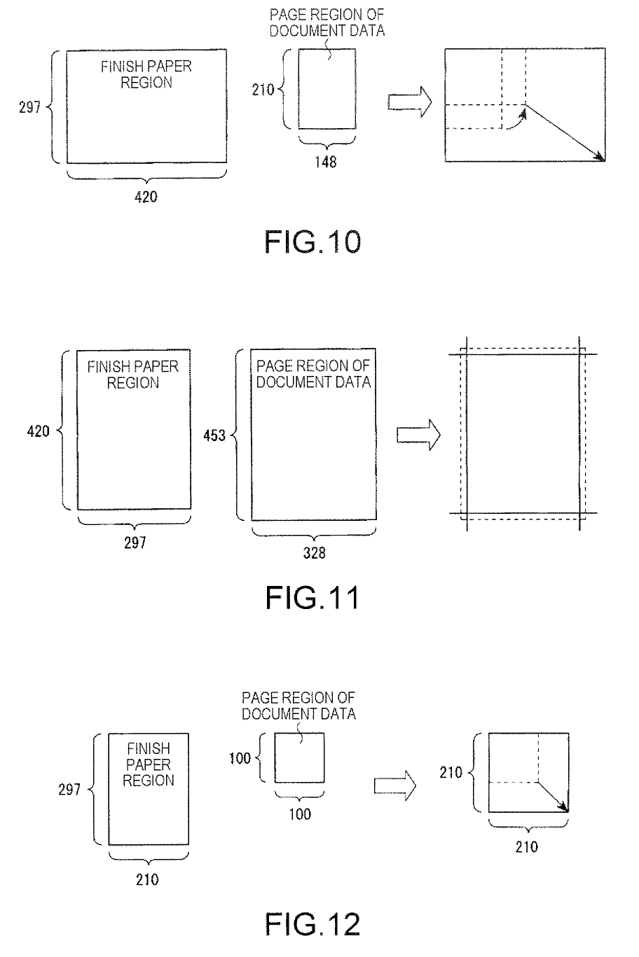

FIG. 10 is a view illustrating a method of processing document data on the basis of the page rotation and enlargement/reduction rule.

As shown in FIG. 10, the page rotation and enlargement/reduction rule specifies that when a ratio between a paper width of a page of document data and a finish paper height is equal to a ratio between a paper height of the page of the document data and a finish paper width, the page is rotated 90° or −90° and then enlarged or reduced in accordance with the finish paper size.

FIG. 11 is a view illustrating a method of processing document data on the basis of the excess region trimming rule.

As shown in FIG. 11, the excess region trimming rule specifies that when both a difference between a paper width of a page of document data and a finish paper width and a difference between a paper height of the page of the document data and a finish paper height are equal to or smaller than a predetermined value, for example, when the difference is equal to or smaller than 5% of the finish paper width or the finish paper height, a part of the page not included in a region specified by the finish paper width and the finish paper height is trimmed.

FIG. 12 is a view illustrating a method of processing document data on the basis of the aspect-ratio-fixed page enlargement/reduction rule.

As shown in FIG. 12, the aspect-ratio-fixed page enlargement/reduction rule specifies that when the whole conditions specified by the normalization rules are not satisfied, the page is fully enlarged or reduced to the finish paper size while maintaining an aspect ratio.

Next, a data structure of a paper size correspondence information table will be described.

The storage device 42 is configured to include the paper size correspondence information storage unit 18 and stores a paper size correspondence information table 400.

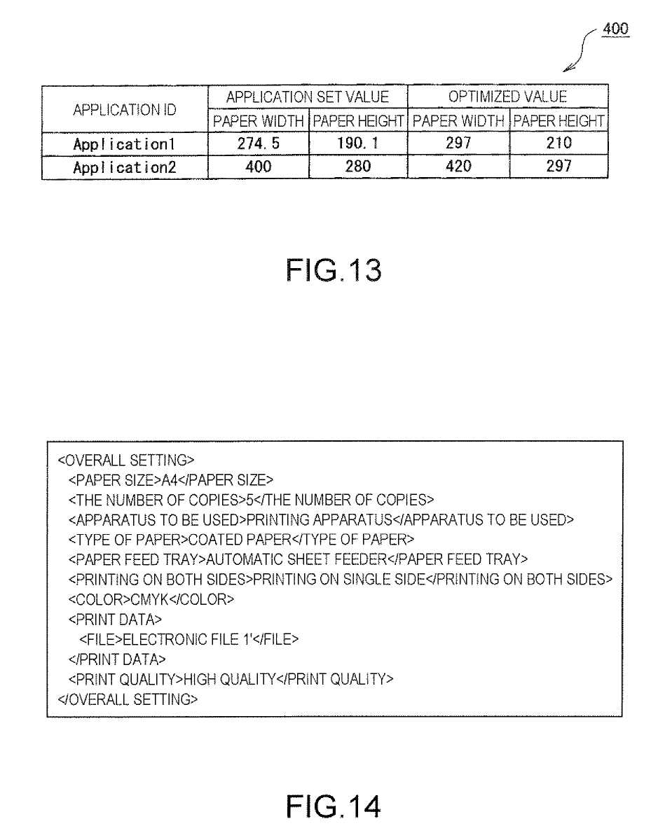

FIG. 13 is a view illustrating the data structure of the paper size correspondence information table 400.

As shown in FIG. 13, in the paper size correspondence information table 400, one record corresponding to each application is registered. Each record includes fields in which an application ID, paper width and paper height set by an application, and paper width and paper height after optimization are respectively registered.

In an example shown in FIG. 13, ‘Application 1’ as an application ID, (274.5, 190.1) as a paper size set by the application, and (297, 210) as a paper size after optimization are registered on a first record. This indicates that in the case when A4 is set by the application ‘Application 1’, (274.5, 190.1) is set as the paper size but an actual A4 paper size is (297, 210), and accordingly, the paper size is converted to (297, 210).

Next, a data structure of the print-setting electronic job ticket will be described.

FIG. 14 is a view illustrating the data structure of the print-setting electronic job ticket.

The print-setting electronic job ticket is electronic data in which detailed print setting on the printing apparatus 200 is described in order to control the printing apparatus 200. As shown in FIG. 14, in the print-setting electronic job ticket, the print setting is performed by describing each tag set, which is composed of a start tag and an end tag, between a predetermined start tag (for example, <overall setting>) and a predetermined end tag (for example, </overall setting>). For example, the tag sets may be described by using a markup language, such as an XML.

The print-setting electronic job ticket includes a lot of setting information unique to the printing apparatus 200 in addition to some of the details of the print-specification electronic job ticket. For example, the setting information unique to the printing apparatus 200 includes print in a unit of the number of copies, setting of a paper feed tray, setting of a paper ejection tray, a save mode, and the like. Here, the setting information unique to the printing apparatus 200 may be manually input by an operator or may be automatically created on the basis of creation rules stored in advance. For example, in the case when a print instruction corresponding to the number of plural copies is described in the print-specification electronic job ticket, the print in a unit of the number of copies may be created, or in the case when the print quality is designated as a draft mode in the print-specification electronic job ticket, a save mode may be created. It is possible to control the printing apparatus 200 by creating the print-setting electronic job ticket on the basis of the print-specification electronic job ticket and inputting the created print-specification electronic job ticket to the printing apparatus 200.

Next, a process performed by the CPU 31 will be described.

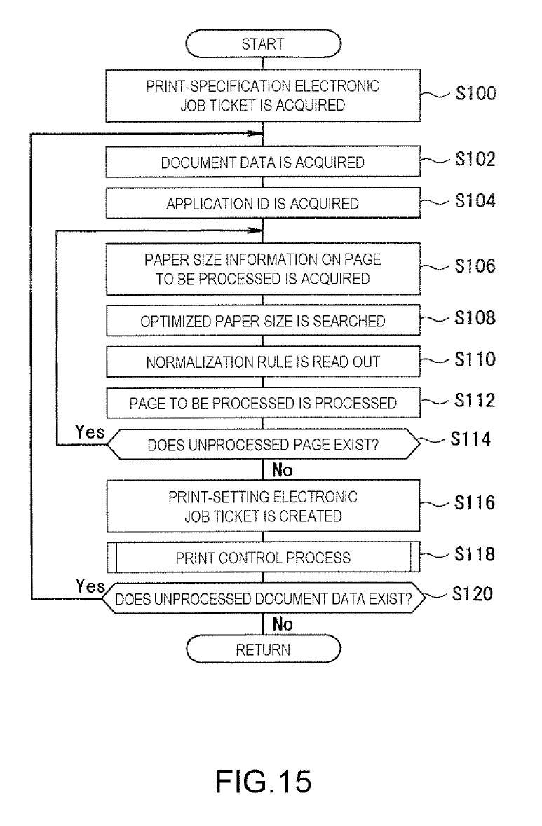

The CPU 30 is composed of, for example, a micro processing unit. The CPU 30 runs a predetermined program stored in a predetermined region of the ROM 32 and then executes a print request process shown in a flow chart of FIG. 15 according to the program.

FIG. 15 is a flow chart illustrating the print request process.

The print request process is a process that requests the printing apparatus 200 to perform a printing. As shown in FIG. 15, if the CPU 30 executes the print request process, the process proceeds to step S100.

In step S100, a print-specification electronic job ticket is acquired, then the process proceeds to step S102 in which document data is acquired, then the process proceeds to step S104 in which an application ID is acquired from an application that has created the acquired document data, and then the process proceeds to step S106. For example, the print-specification electronic job ticket and the document data may be acquired through the network 199 or may be read out from an external storage medium, such as the storage device 42 or a flash memory.

In step S106, unprocessed pages are set as objects to be processed sequentially from a front page of the acquire document data and paper size information on the pages to be processed, then the process proceeds to step S108 in which the paper width and paper height after optimization corresponding to the paper width and paper height of the paper size information and the application ID that have been acquired are searched from the paper size correspondence information table 400, and then process proceeds to step S110.

In step S110, on the basis of the detected paper width and paper height after the optimization and finish paper width and finish paper height of the acquired print-specification electronic job ticket, a normalization rule suitable for the relation therebetween is read out from the storage device 42, then the process proceeds to step S112 in which the pages to be processed are processed in accordance with the read normalization rule, and then the process proceeds to step S114.

In step S114, it is determined whether or not an unprocessed page exists in the acquired document data. If it is determined that the unprocessed page does not exist (No), the process proceeds to step S116.

In step S116, a print-setting electronic job ticket including a print setting on the printing apparatus 200 is created on the basis of the acquired print-specification electronic job ticket, then the process proceeds to step S118 in which a print control process that requests the printing apparatus 200 to perform a printing is executed on the basis of the created print-setting electronic job ticket and the processed document data, and then the process proceeds to step S120.

In step S120, it is determined whether or not unprocessed document data exists in the storage device 42. If it is determined that the unprocessed document data does not exist (No), a series of processes is completed, returning to an original process.

On the other hand, in step S102, if it is determined that the unprocessed document data exists (Yes), the process proceeds to step S102.

On the other hand, in step S114, if it is determined that the unprocessed page exists (Yes), the process proceeds to step S106.

Next, an operation of the present embodiment will be described.

In the host terminal 100, the print-specification electronic job ticket, the document data, and the application ID are acquired in steps S100 to S104. Then, in steps S106 to S108, the front page of the document data is set as an object to be processed, the paper size information of the page to be processed is acquired, and the paper size after optimization is searched on the basis of the application ID and the paper size information. Thereafter, in steps S110 and 112, the normalization rule is read out on the basis of the paper size after optimization and the finish paper size of the print-specification electronic job ticket, and then the page to be processed is processed on the basis of the read normalization rule. In the same manner, subsequent pages are also processed on the basis of the normalization rule according to the relation between the document set paper size and the finish paper size in steps S106 to S112.

If the processes described above are performed with respect to all of the pages, in steps S116 and S118, the print-setting electronic job ticket is created, a print setting described in the print-setting electronic job ticket is automatically performed with respect to the printing apparatus 200, and then a print command of the processed document data is issued to the printing apparatus 200. As a result, it is possible to obtain a printed material, for which an imposition process is properly performed, from the printing apparatus 200.

Next, a post process after the printing will be described.

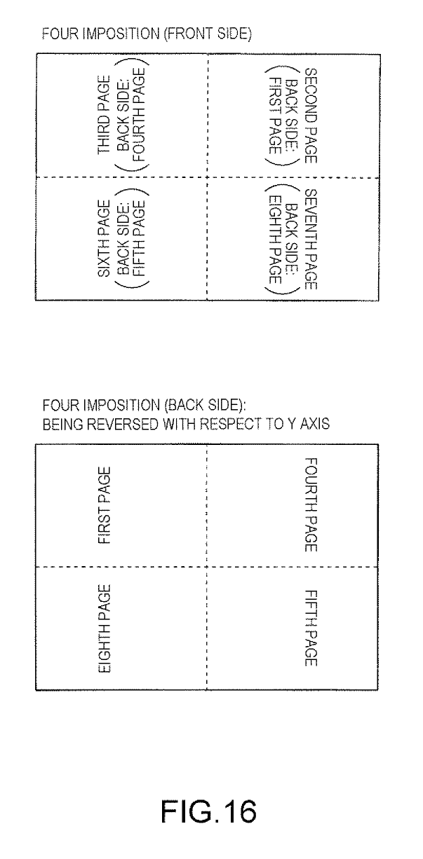

FIG. 16 is a view illustrating an example in which four pages are imposed on each of both sides of a piece of paper.

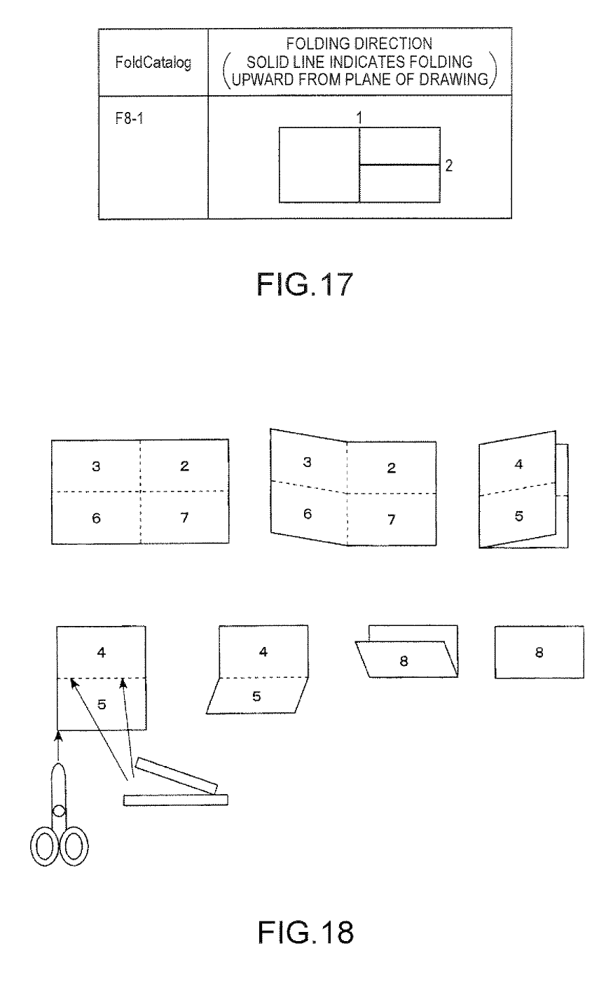

FIG. 17 is a view illustrating a setting example of a paper folding direction.

FIG. 18 is a view illustrating a sequence of folding the paper.

A purpose of unifying paper sizes of the document data is to properly perform an imposition process. The imposition means that a plurality of pages are disposed on paper larger than the finish paper size. For example, a case in which the finish paper size is subjected to four imposition is shown in FIG. 16. For example, it is assumed that the folding method shown in FIG. 17 is set in the print-specification electronic job ticket. In this case, as shown in FIG. 18, paper is bent by folding about half of the paper in the left and right direction, a left side of the paper is cut off, a central portion of the paper in the up and down direction thereof is filed by using a stapler, and the paper is bent by folding about half of the paper in the up and down direction, thereby performing the bookbinding.

Here, ‘F8-1’ is a kind of a unique identifier that indicates a paper folding method and refers to a folding method in a case in which four pages are respectively assigned on both sides of print paper. The ‘F8-1’ indicates bending the print paper by folding about half of the print paper in the left and right direction and bending the print paper by folding about half of the print paper in the up and down direction.

In order to properly perform the bookbinding, all of the pages of the document data should be equal to or smaller than the finish paper size. In addition, in order to obtain a good bookbinding result, it is preferable that paper sizes of all of the pages be equal. For this reason, in the present embodiment, it is intended to match the sizes of all of the pages of the page data as much as possible.

Next, a specific embodiment will be described.

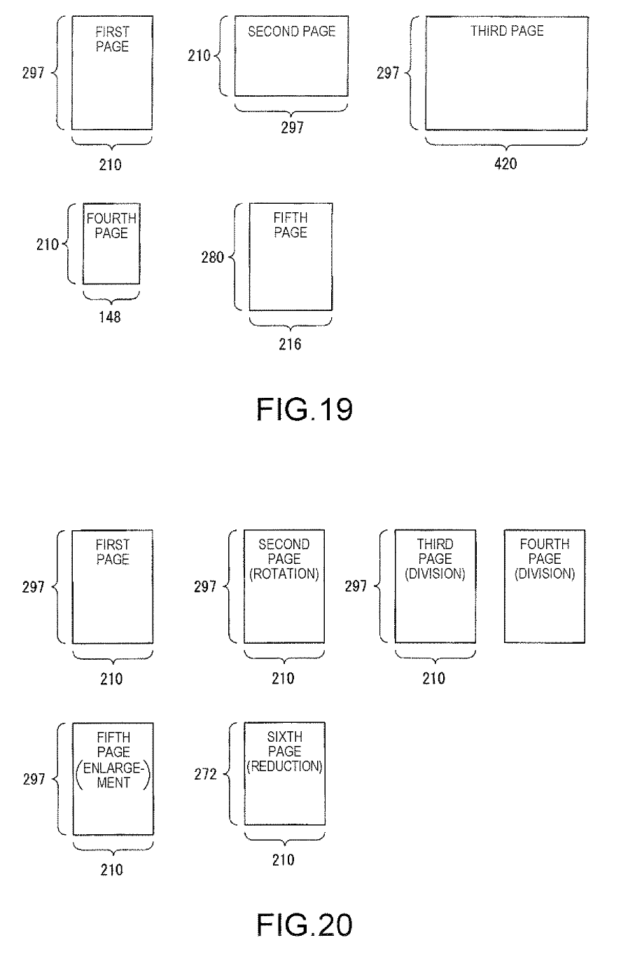

FIG. 19 is a view illustrating the data structure of document data before processing is performed.

FIG. 20 is a view illustrating the data structure of the document data after the processing has been performed.

In the case of document data shown in FIG. 19, a process result shown in FIG. 20 can be obtained.

On a first page, since the paper size of a page of the document data is equal to the finish paper size, processing is not performed.

On a second page, since the paper width of a page of the document data is equal to the finish paper height and the paper height of a page of the document data is equal to the finish paper width, the page rotation rule is applied, so that the corresponding page is rotated 90°.

On a third page, since the paper width of a page of the document data is twice the finish paper width and the paper height of a page of the document data is equal to the finish paper height, the width-direction page division rule is applied, so that the corresponding page is divided into two equal parts in the paper width direction. Here, an order of the divided pages may be an order of left and right or an order of right and left. In addition, if filing positions are designated as print specifications, the order of left and right may be applied to a case of a left filing and the order of right and left may be applied to a case of a right filing.

On a fourth page, since a ratio between the paper width of a page of the document data and the finish paper width is equal to a ratio between the paper height of a page of the document data and the finish paper height, which are all 1:1.4, the page enlargement/reduction rule is applied, so that the corresponding page is enlarged in accordance with the finish paper size.

On a fifth page, since all of the conditions described above are not satisfied, the aspect-ratio-fixed page enlargement/reduction rule is applied, so that the corresponding page is fully reduced to the finish paper size while maintaining an aspect ratio.

As described above, in the present embodiment, the processing is performed for each page in consideration of the relation between the document set paper size and the finish paper size.

In contrast, in the related art, the following processing is performed.

In the technique disclosed in JP-A-3-216370, since the paper size can be adjusted only by the enlargement/reduction, second and third pages in the document data shown in FIG. 19 become extremely small.

In the technique disclosed in JP-A-2004-199464, a page corresponding to a paper size larger than a basic size is divided into a plurality of pages so as to make the entire pages equal to or smaller than the basic size. As a result, a third page in the document data shown in FIG. 19 is divided into two pages; however, the second, fourth, and fifth pages are not processed.

In the technique disclosed in JP-A-11-48573, since the paper size can be adjusted only by the enlargement/reduction and the rotation, the third page in the document data shown in FIG. 19 is reduced and rotated. In the case when the third page is double pages of left and right, the page division is preferable.

In the technique disclosed in JP-A-2005-56285, the processing is performed only when it is determined to be oversized. As a result, in the same manner as in JP-A-2004-199464, the third page in the document data shown in FIG. 19 is processed; however, the second, fourth, and fifth pages are not processed.

Thus, in the present embodiment, the document data in which the paper size with respect to each of the plurality of pages can be set is acquired, the print-specification electronic job ticket including the finish paper size of the printed material is acquired, one of the normalization rules is selected on the basis of the paper size of the acquired document data and the finish paper size of the acquired print-specification electronic job ticket, and the document data is processed on the basis of the selected normalization rule.

Accordingly, the document data is processed in consideration of the relation between the document set paper size and the finish paper size. As a result, as compared with the related art, it is possible to obtain a print result suitable for being cut for bookbinding and being page-folded.

moreover, in the present embodiment, if it is determined that the paper width of the page of the document data is ‘N’ times the finish paper width and the paper height of the page of the document data is equal to the finish paper height, the width-direction page division rule by which the page is divided into ‘N’ equal parts in the paper width direction is selected.

Thus, it is possible to process the page, of which the paper width is ‘N’ times the finish paper width and the paper height is equal to the finish paper height, of the document data, so as to be visually good.

Further, in the present embodiment, if it is determined that the paper height of the page of the document data is ‘M’ times the finish paper height and the paper width of the page of the document data is equal to the finish paper width, the height-direction page division rule by which the page is divided into ‘M’ equal parts in the paper height direction is selected.

Thus, it is possible to process the page, of which the paper height is ‘M’ times the finish paper height and the paper width is equal to the finish paper width, of the document data, so as to be visually good.

Furthermore, in the present embodiment, if it is determined that the ratio between the paper width of the page of the document data and the finish paper width is equal to the ratio between the paper height of the page of the document data and the finish paper height, the page enlargement/reduction rule by which the page is enlarged or reduced in accordance with the finish paper size is selected.

Thus, it is possible to process a page so as to be visually good a ratio between the paper width of the page of the document data and the finish paper width being equal to a ratio between the paper height of the page of the document data and the finish paper height.

In addition, in the present embodiment, if it is determined that the paper width of the page of the document data is equal to the finish paper height and the paper height of the page of the document data is equal to the finish paper width, the page rotation rule by which the page is rotated 90° or −90° is selected.

Thus, it is possible to process the page, of which the paper width is equal to the finish paper height and the paper height is equal to the finish paper width, of the document data, so as to be visually good.

In addition, in the present embodiment, the page is rotated such that the characters included in a page after the rotation are positioned upward or rightward as a result of the rotation.

Accordingly, since the characters are positioned in the predetermined direction, it is possible to obtain a print result suitable for being cut for bookbinding and being page-folded.

Furthermore, in the present embodiment, if it is determined that the ratio between the paper width of the page of the document data and the finish paper height is equal to the ratio between the paper height of the page of the document data and the finish paper width, the page rotation and enlargement/reduction rule by which the page is rotated 90° or −90° and then enlarged or reduced in accordance with the finish paper size is selected.

Thus, it is possible to process a page so as to be visually good, a ratio between the paper width of the page of the document data and the finish paper height being equal to a ratio between the paper height of the page of the document data and the finish paper width.

Furthermore, in the present embodiment, if it is determined that both a difference between the paper width of the page of the document data and the finish paper width and a difference between the paper height of the page of the document data and the finish paper height are equal to or smaller than a predetermined value, the excess region trimming rule by which a part of the page not included in a region specified by the finish paper size is trimmed is selected.

Thus, it is possible to process a page so as to be visually good, both a difference between the paper width of of the page of the document data and the finish paper width and a difference between the paper height of the page of the document data and the finish paper height being equal to or smaller than the predetermined value.

In addition, in the present embodiment, the application ID is acquired, the paper size after optimization corresponding to the acquire application ID and the paper size of the document data is searched in the paper size correspondence information table 400, and the normalization rule is selected on the basis of the finish paper size and the paper size after optimization.

Thus, even in the case when the settings for indicating the same paper size are different according to applications, the processing can be properly performed.

In the embodiment described above, the normalization rule storage unit 14 and the storage device 42 correspond to the normalization rule storage unit according to any one of the first, fourth to seventh, ninth to twelfth, fifteenth to eighteenth, twentieth to twenty-third, twenty-sixth to twenty-ninth, thirty-first to thirty-fifth, thirty-eighth to forty-first, and forty-third to forty-fifth aspects, and each of the paper size correspondence information storage unit 18 and the storage device 42 corresponds to the paper size correspondence information storage unit according to the eleventh, twenty-second, thirty-third, or forty-fifth aspect. In addition, the document data acquisition unit 10 and the step S102 correspond to the document data acquisition unit according to the first, third, or eleventh aspect, the step S102 corresponds to the document data acquiring step according to any one of the twelfth to fourteenth, twenty-second to twenty-fifth, thirty-third to thirty-seventh, and forty-fifth aspects, and the print-specification electronic job ticket acquisition unit 12 and the step S100 correspond to the finish paper size information acquisition unit according to the first, third, or eleventh aspect.

Furthermore, in the embodiment described above, the step S100 corresponds to the finish paper size information acquiring step according to any one of the twelfth to fourteenth, twenty-second to twenty-fifth, thirty-third to thirty-seventh, and forty-fifth aspects, and the application ID acquisition unit 16 and the step S104 correspond to the application identification information acquisition unit according to the eleventh aspect. Moreover, the step S104 corresponds to the application identification information acquiring step according to the twenty-second, thirty-third, or forty-fifth aspect, the optimized paper size search unit 20 and the step S108 correspond to the optimized paper size search unit according to the eleventh aspect, and the step S108 corresponds to the optimized paper size searching step according to the twenty-second, thirty-third, or forty-fifth aspect.

In addition, in the embodiment described above, the normalization rule selection unit 22 and the step S110 correspond to the normalization rule selection unit according to any one of the first, fourth to seventh, and ninth to eleventh aspects, the step S110 corresponds to the normalization rule selecting step according to any one of the twelfth, fifteenth to eighteenth, twentieth to twenty-third, twenty-sixth to twenty-ninth, thirty-first to thirty-fifth, thirty-eighth to forty-first, and forty-third to forty-fifth aspects. In addition, the document data processing unit 24 and step S112 correspond to the document data processing unit according to any one of the first and fourth to tenth aspects, and the step S112 corresponds to the document data processing step according to any one of the twelfth, fifteenth to twenty-first, twenty-third, twentysixth to thirty-second, thirty-fourth, thirty-fifth, and thirty-eighth to forty-fourth aspects.

In addition, in the embodiment described above, the application ID corresponds to the application identification information according to the eleventh, twenty-second, thirty-third, or forty-fifth aspect, and the CPU 30 corresponds to the operation unit according to the thirty-fifth aspect.

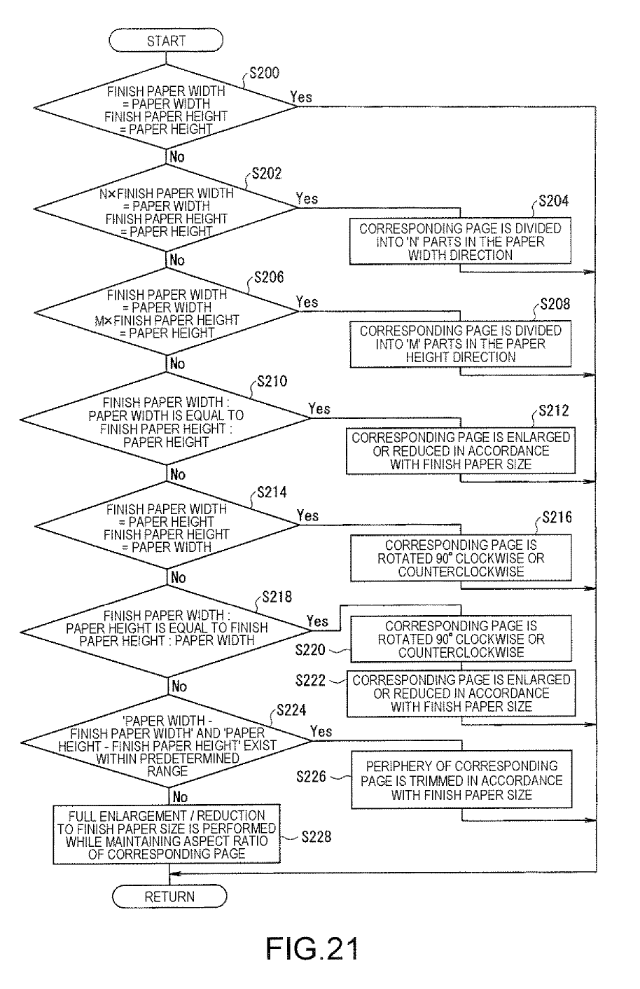

Moreover, in the embodiment described above, the document data is processed under the state in which the plurality of normalization rules is prepared; however, the invention is not limited thereto. For example, without preparing the normalization rules, the document data may be processed through determination made by a program. Specifically, processing shown in a flow chart of FIG. 21 is executed instead of the processing performed in steps S110 and S112.

FIG. 21 is a flow chart illustrating processing procedures.

If the processing starts, first, the process proceeds to step S200, as shown in FIG. 21.

In step S200, it is determined whether or not the paper width and paper height of the page of the document data are equal to the finish paper width and finish paper height. If it is determined that the paper width and paper height of the page of the document data are equal to the finish paper width and finish paper height (Yes), a series of processes is completed, returning to an original process.

On the other hand, in step S200, if it is determined that one of the paper width and paper height of the page of the document data is not equal to one of the finish paper width and finish paper height (No), the process proceeds to step S202. In step S202, it is determined whether or not the paper width of the page of the document data is ‘N’ times the finish paper width and the paper height of the page of the document data is equal to the finish paper height. If it is determined that the paper width of the page of the document data is ‘N’ times the finish paper width and the paper height of the page of the document data is equal to the finish paper height (Yes), the process proceeds to step S204. In step S204, the page is divided into ‘N’ equal parts in the paper width direction and then a series of processes are completed, returning to the original process.

On the other hand, in step S202, if it is determined that the paper width of the page of the document data is not ‘N’ times the finish paper width and the paper height of the page of the document data is not equal to the finish paper height (No), the process proceeds to step S206. In step S206, it is determined whether or not the paper height of the page of the document data is ‘M’ times the finish paper height and the paper width of the page of the document data is equal to the finish paper width. If it is determined that the paper height of the page of the document data is ‘M’ times the finish paper height and the paper width of the page of the document data is equal to the finish paper width (Yes), the process proceeds to step S208. In step S208, the page is divided into ‘M’ equal parts in the paper height direction and then a series of processes are completed, returning to the original process.

On the other hand, in step S206, if it is determined that the paper height of the page of the document data is not ‘M’ times the finish paper height and the paper width of the page of the document data is not equal to the finish paper width (No), the process proceeds to step S210. In step S210, it is determined whether or not the ratio between the paper width of the page of the document data and the finish paper width is equal to the ratio between the paper height of the page of the document data and the finish paper height. If it is determined that the ratio between the paper width of the page of the document data and the finish paper width is equal to the ratio between the paper height of the page of the document data and the finish paper height (Yes), the process proceeds to step S212. In step S212, the page is enlarged or reduced in accordance with the finish paper size and then a series of processes are completed, returning to the original process.

On the other hand, in step S210, if it is determined that the ratio between the paper width of the page of the document data and the finish paper width is not equal to the ratio between the paper height of the page of the document data and the finish paper height (No), the process proceeds to step S214. In step S214, it is determined whether or not the paper width of the page of the document data is equal to the finish paper height and the paper height of the page of the document data is equal to the finish paper width. If it is determined that the paper width of the page of the document data is equal to the finish paper height and the paper height of the page of the document data is equal to the finish paper width (Yes), the process proceeds to step S216. In step S216, the page is rotated 90° or −90° and then a series of processes are completed, returning to the original process.

On the other hand, in step S214, if it is determined that the paper width of the page of the document data is not equal to the finish paper height or the paper height of the page of the document data is not equal to the finish paper width (No), the process proceeds to step S218. In step S218, it is determined whether or not the ratio between the paper width of the page of the document data and the finish paper height is equal to the ratio between the paper height of the page of the document data and the finish paper width. If it is determined that the ratio between the paper width of the page of the document data and the finish paper height is equal to the ratio between the paper height of the page of the document data and the finish paper width (Yes), the process proceeds to step S220. In step S220, the page is rotated 90° or −90° and then the process proceeds to step S222. In step S222, the page is enlarged or reduced in accordance with the finish paper size and then a series of processes are completed, returning to the original process.

On the other hand, in step S218, if it is determined that the ratio between the paper width of the page of the document data and the finish paper height is not equal to the ratio between the paper height of the page of the document data and the finish paper width (No), the process proceeds to step S224. In step S224, it is determined whether or not both a difference between the paper width of the page of the document data and the finish paper width and a difference between the paper height of the page of the document data and the finish paper height are equal to or smaller than the predetermined value. If it is determined that both the difference between the paper width of the page of the document data and the finish paper width and the difference between the paper height of the page of the document data and the finish paper height are equal to or smaller than the predetermined value (Yes), the process proceeds to step S226. In step S226, a part of the page not included in a region specified by the finish paper size is trimmed and a series of processes are completed, returning to the original process.

On the other hand, in step S224, if it is determined that the difference between the paper width of the page of the document data and the finish paper width is larger than the predetermined value or the difference between the paper height of the page of the document data and the finish paper height is larger than the predetermined value (No), the process proceeds to step S228. In step S228, the page is fully enlarged or reduced to the finish paper size while maintaining the aspect ratio and then a series of processes are completed, returning to the original process.

Further, in the embodiment described above, the normalization rule is read out from the storage device 42 and then immediately the document data is processed on the basis of the read normalization rule. However, the invention is not limited thereto. For example, it may be possible to stop an output of a processing command for processing the document data after reading out the normalization rule and then to input an output processing command to the printing apparatus 200 in a print control process of requesting the printing apparatus 200 to perform a printing such that the printing apparatus 200 processes the document data.

By using the configuration described above, if the printing apparatus 200 has a function of processing and drawing the document data, it is possible to cause the printing apparatus 200 to process the document data by using the function.

In addition, even if the document data is processed according to the normalization rule, there is a case in which the connected printing apparatus 200 is not capable of performing the print process. For example, a print process in the case when the finish paper size is A3 cannot be performed in the printing apparatus 200 which corresponds up to only A4. In this case, the processing for the document data is wasted. At this time, if the document data is processed in the print control process, it is determined whether or not the document data can be printed by the printing apparatus 200 and then the document data is processed. As a result, the processing for the document data is not wasted.

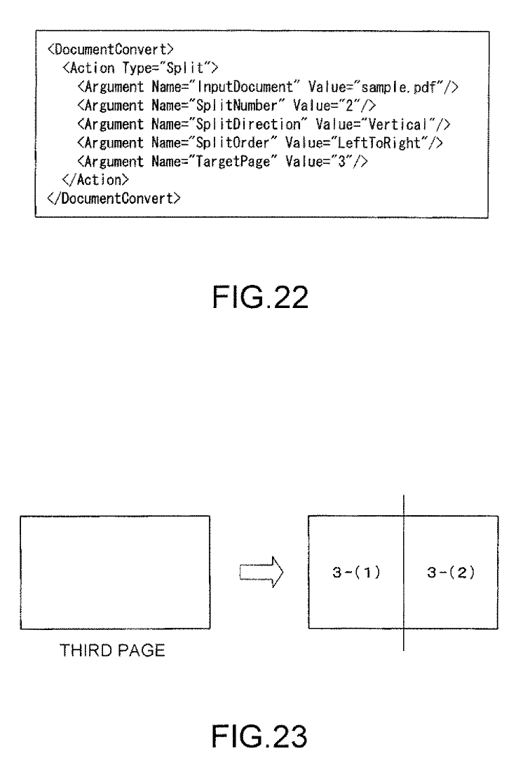

FIG. 22 is a view illustrating the data structure of a processing command.

FIG. 23 is a view illustrating a method of processing document data on the basis of the processing command.

Here, the processing command for processing the document data may be described by using, for example, an XML file shown in FIG. 22. As shown in FIG. 23, the processing command describes a command that causes a third page of document data, which is called ‘sample.pdf’, to be divided into two parts in the paper width direction and a left one of the divided pages to become a preceding page. Further, in the case of transmitting the processing command of the document data to the printing apparatus 200, the processing command may be transmitted as the XML file such that the printing apparatus 200 analyzes and executes the corresponding XML file, or the processing command may be transmitted to the printing apparatus 200 after converting the XML file to a print description language, such as PostScript, beforehand.

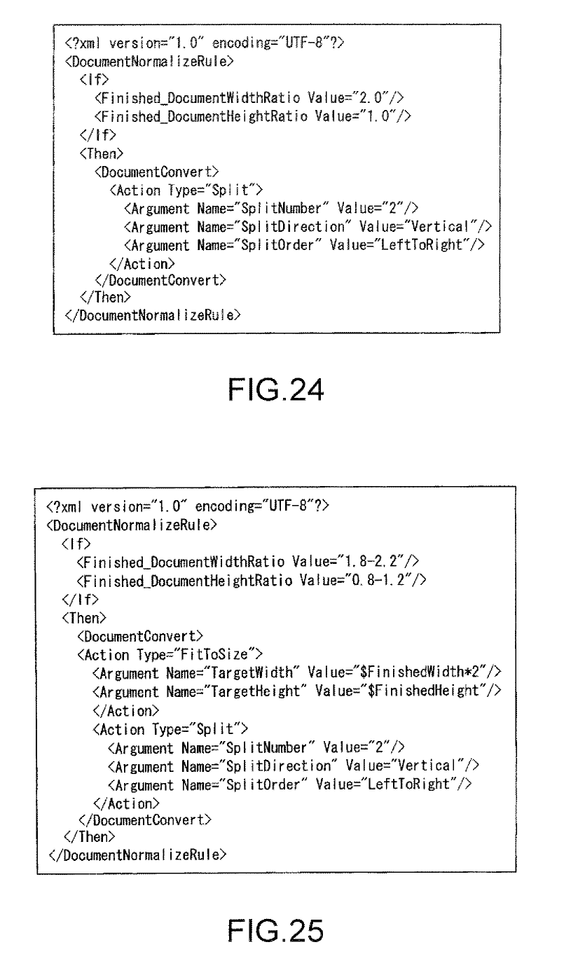

Furthermore, in the embodiment described above, absolute values of the paper size of the document data and the finish paper size are described as the normalization rules; however, the invention is not limited thereto. For example, the ratio between the paper size of the document data and the finish paper size may be described. An example of a normalization rule that describes a ratio is shown in FIG. 24.

FIG. 24 is a view illustrating the data structure of the normalization rule.

The example shown in FIG. 24 corresponds to a rule in the case when the ratio between the finish paper width and the paper width of the document data is 2.0, that is, the paper width of the document data is twice the finish paper width and the ratio between the finish paper height and the paper height of the document data is 1.0, that is, the paper height of the document data is equal to the finish paper height.

By using the above rule description method, it is possible to cause a single rule to correspond to all cases in which the paper ratios are equal, regardless of the paper size. For example, the rule shown in FIG. 24 can be applied to both a case in which the finish paper size corresponds to A4 Portrait and the paper size of the document data corresponds to A3 Landscape and a case in which the finish paper size corresponds to A5 Portrait and the paper size of the document data corresponds to A4 Landscape, it is possible to obtain an effect in which the number of normalization rules can be reduced.

Moreover, in the example shown in FIG. 24, even though the ratio between paper sizes is a fixed value, it is possible to specify a predetermined range for the ratio. Thus, even in the case when the ratio between paper sizes does not completely match a predetermined value, a desired normalization process can be performed if the ratio exists within the predetermined range. FIG. 25 illustrates an example in which a range for the ratio is specified.

FIG. 25 is a view illustrating the data structure of the normalization rule.

In the example shown in FIG. 25, there is disclosed a rule in which, when the ratio between the finish paper width and the paper width of the document data exists within a range of 1.8 to 2.2 and the ratio between the finish paper height and the paper height of the document data exists within a range of 0.8 to 1.2, the paper width of the document data is adjusted to be twice the finish paper width and the paper height of the document data is adjusted to be equal to the finish paper height and then the document data is divided into two parts in the width direction.

In addition, in the embodiment described above, only the document set paper size and the finish paper size are described as conditions of the normalization rule. However, other conditions may be added without being limited thereto. For example, in the case when the type of a document is described as metadata in the document data, in order to change an applied rule according to the type of the document, the metadata of the document data is added as a condition.

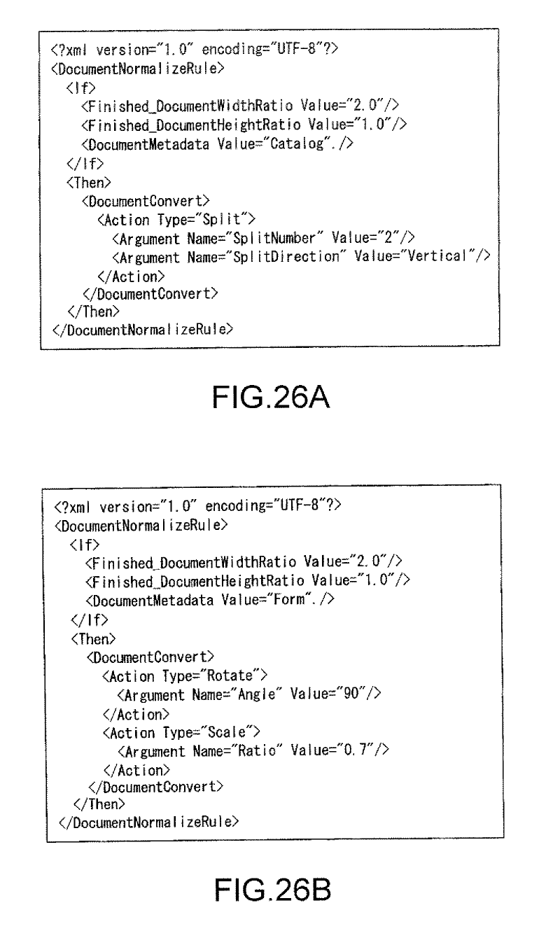

FIGS. 26A and 26B are views each illustrating the data structure of a normalization rule.

By using the data structures described above, for example, in the case when the finish paper size corresponds to A4 Portrait and the paper size of the document data corresponds to A3 Landscape, it is possible to perform a process of dividing the document data into two parts in the paper width direction if the document data corresponds to a product catalogue (FIG. 26A) and to perform a process of rotating and reducing the document data if the document data corresponds to a ledger sheet (FIG. 26B).

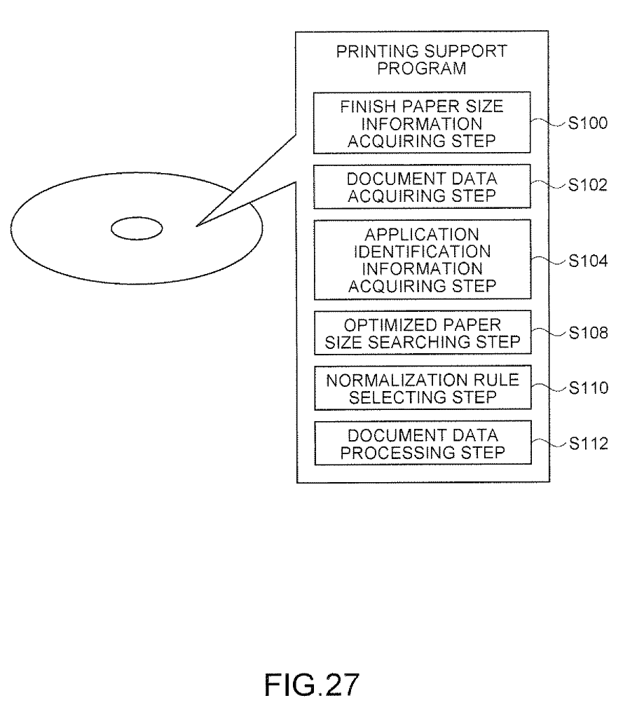

Furthermore, in the embodiment described above, the case has been described in which a control program stored beforehand in the ROM 32 is executed to perform the print request process shown in the flow chart of FIG. 15. However, the invention is not limited thereto. For example, as shown in FIG. 27, under a state in which a program indicating these procedures is stored in a storage medium, it may be possible to cause the RAM 34 to read out the program so as to be executed. In addition, this can also be applied to the print request process shown in the flow chart of FIG. 21.

FIG. 27 is a view illustrating a storage medium and the data structure thereof.

Here, the storage medium includes a semiconductor storage medium, such as a RAM or a ROM, a magnetic recordable storage medium, such as an FD or an HD, an optically readable storage medium, such as a CD, a CDV, an LD, or a DVD, and a magnetically recordable and optically readable storage medium, such as an MO. Specifically, any storage media may be used as long as it is a computer-readable storage medium, regardless of reading methods such as electronic, magnetic, and optical methods.

Furthermore, in the embodiment described above, the printing support system, the printing support program, the storage medium, and the printing support method according to the embodiment of the invention have been applied to the case in which printing is performed by the printing apparatus 200 by using the print-specification electronic job ticket. However, the invention is not limited thereto. For example, the invention may be applied to other cases without departing from the subject matter of the invention.

The entire disclosure of Japanese Patent Application Nos. 2005-311456, filed Oct. 26, 2005 and 2006-214069, filed Aug. 7, 2006 are expressly incorporated by reference herein.

What is claimed is:

1. A printing support system that supports performing a printing process on the basis of document data allowing paper width and paper height to be set for each of a plurality of pages, comprising:
a document data acquisition unit that acquires the document data;
a finish paper size information acquisition unit that acquires finish paper size information indicating finish paper width and finish paper height of a printed material;
a normalization rule storage unit that stores a plurality of normalization rules used to process the document data such that paper widths and paper heights of entire pages of the document data are adapted to the finish paper width and finish paper height of the finish paper size information;
a normalization rule selection unit that selects the normalization rules in the normalization rule storage unit on the basis of the paper width and paper height of the document data acquired by the document data acquisition unit and the finish paper width and finish paper height of the finish paper size information acquired by the finish paper size information acquisition unit; and
a document data processing unit that processes the document data acquired by the document data acquisition unit on the basis of the normalization rule selected by the normalization rule selection unit.

2. The printing support system according to claim 1,
wherein the finish paper size information acquisition unit acquires, as the finish paper size information, paper width and paper height of a front page of the document data acquired by the document data acquisition unit.

3. The printing support system according to claim 1,
wherein the finish paper size information acquisition unit acquires, as the finish paper size information, paper width and paper height of a page, of which paper width and paper height are minimum, of the document data acquired by the document data acquisition unit.

4. The printing support system according to claim 1,
wherein the normalization rule storage unit stores, as the normalization rule, at least a width-direction page division rule by which a page of the document data is divided into ‘N’ (‘N’ is an integer equal to or larger than 2) equal parts in the paper width direction,
the normalization rule selection unit selects the width-direction page division rule in the normalization rule storage unit if it is determined that a paper width of the page of the document data is ‘N’ times the finish paper width and a paper height of the page of the document data is equal to the finish paper height, and
the document data processing unit processes the page of the document data on the basis of the width-direction page division rule selected by the normalization rule selection unit.

5. The printing support system according to claim 1,
wherein the normalization rule storage unit stores, as the normalization rule, at least a height-direction page division rule by which a page of the document data is divided into ‘M’ (‘M’ is an integer equal to or larger than 2) equal parts in the paper height direction,
the normalization rule selection unit selects the height-direction page division rule in the normalization rule storage unit if it is determined that a paper height of the page of the document data is ‘M’ times the finish paper height and a paper width of the page of the document data is equal to the finish paper width, and
the document data processing unit processes the page of the document data on the basis of the height-direction page division rule selected by the normalization rule selection unit.

6. The printing support system according to claim 1,
wherein the normalization rule storage unit stores, as the normalization rule, at least a page enlargement/reduction rule by which a page of the document data is enlarged or reduced in accordance with the finish paper width and the finish paper height,
the normalization rule selection unit selects the page enlargement/reduction rule in the normalization rule storage unit if it is determined that a ratio between a paper width of the page of the document data and the finish paper width is equal to a ratio between a paper height of the page of the document data and the finish paper height, and
the document data processing unit processes the page of the document data on the basis of the page enlargement/reduction rule selected by the normalization rule selection unit.

7. The printing support system according to claim 1,
wherein the normalization rule storage unit stores, as the normalization rule, at least a page rotation rule by which a page of the document data is rotated 90° or −90°,
the normalization rule selection unit selects the page rotation rule in the normalization rule storage unit if it is determined that a paper width of the page of the document data is equal to the finish paper height and a paper height of the page of the document data is equal to the finish paper width, and
the document data processing unit processes the page of the document data on the basis of the page rotation rule selected by the normalization rule selection unit.

8. The printing support system according to claim 7, further comprising:
a character direction determination unit that determines a direction of a character included in a page,
wherein the document data processing unit rotates the page of the document data on the basis of the direction of the character included in the page, which has been determined by the character direction determination unit, such that the character included in the page after the rotation is positioned upward or rightward as a result of having rotated the page of the document data.

9. The printing support system according to claim 1,
wherein the normalization rule storage unit stores, as the normalization rule, at least a page rotation and enlargement/reduction rule by which a page of the document data is rotated 90° or −90° and enlarged or reduced in accordance with the finish paper width and the finish paper height,
the normalization rule selection unit selects the page rotation and enlargement/reduction rule in the normalization rule storage unit if it is determined that a ratio between a paper width of the page of the document data and the finish paper height is equal to a ratio between a paper height of the page of the document data and the finish paper width, and
the document data processing unit processes the page of the document data on the basis of the page rotation and enlargement/reduction rule selected by the normalization rule selection unit.

10. The printing support system according to claim 1,
wherein the normalization rule storage unit stores, as the normalization rule, at least an excess region trimming rule by which a part of a page region of the document data, which is not included in a region specified by the finish paper width and the finish paper height, is trimmed,
the normalization rule selection unit selects the excess region trimming rule in the normalization rule storage unit if it is determined that both a difference between a paper width of the page of the document data and the finish paper width and a difference between a paper height of the page of the document data and the finish paper height are equal to or smaller than a predetermined value, and
the document data processing unit processes the page of the document data on the basis of the excess region trimming rule selected by the normalization rule selection unit.

11. The printing support system according to claim 1, further comprising:
an application identification information acquisition unit that acquires application identification information for identifying an application by which the document data has been created;
a paper size correspondence information storage unit that stores the application identification information, paper width and paper height set by the application, and paper width and paper height after optimization in such a manner that the application identification information, the paper width and paper height set by the application, and the paper width and paper height after the optimization correspond to one another; and
an optimized paper size search unit that searches, in the paper size correspondence information storage unit, the paper width and paper height after the optimization corresponding to the paper width and paper height of the document data acquired by the document data acquisition unit and the application identification information acquired by the application identification information acquisition unit,
wherein the normalization rule selection unit selects the normalization rules in the normalization rule storage unit on the basis of the paper width and paper height after the optimization searched by the optimized paper size search unit and the finish paper width and finish paper height of the finish paper size information acquired by the finish paper size information acquisition unit.

12. A computer-readable storage medium storing a printing support program that supports performing a printing process on the basis of document data allowing paper width and paper height to be set for each of a plurality of pages, comprising:
a program causing a computer to execute:
acquiring the document data;
acquiring finish paper size information indicating finish paper width and finish paper height of a printed material;
selecting a normalization rule in a normalization rule storage unit, which stores a plurality of normalization rules used to process the document data such that paper widths and paper heights of entire pages of the document data are adapted to the finish paper width and finish paper height of the finish paper size information, on the basis of the paper width and paper height of the document data acquired in the acquiring of the document data and the finish paper width and finish paper height of the finish paper size information acquired in the acquiring of the finish paper size information; and
processing the document data acquired in the acquiring of the document data on the basis of the normalization rule selected in the selecting of the normalization rule.

13. A printing support method that supports performing a printing process on the basis of document data allowing paper width and paper height to be set for each of a plurality of pages, comprising:
acquiring the document data;
acquiring finish paper size information indicating finish paper width and finish paper height of a printed material;
selecting a normalization rule in a normalization rule storage unit, which stores a plurality of normalization rules used to process the document data such that paper widths and paper heights of entire pages of the document data are adapted to the finish paper width and finish paper height of the finish paper size information, on the basis of the paper width and paper height of the document data acquired in the acquiring of the document data and the finish paper width and finish paper height of the finish paper size information acquired in the acquiring of the finish paper size information; and
processing the document data acquired in the acquiring of the document data on the basis of the normalization rule selected in the selecting of the normalization rule.
